(19) United States
(12) Patent Application Publication
(10) Pub. No.: US 2017/0071804 A1
(43) Pub. Date: Mar. 16, 2017

(54) POWERED WHEELCHAIR

(71) Applicant: REAC AB, Amal (SE)

(72) Inventor: Carl Johan Olsson, Amal (SE)

(21) Appl. No.: 15/308,084

(22) PCT Filed: Apr. 29, 2014
(86) PCT No.: PCT/EP2014/058652

§ 371 Date: Oct. 31, 2016

(51) Int. Cl. A61G 5/04; A61G 5/10; A61G 5/12; A61G 5/06

(52) U.S. Cl. CPC A61G 5/042; A61G 5/06; A61G 5/1089; A61G 5/125; A61G 5/128; A61G 2203/14; A61G 2203/42

(57) ABSTRACT

The invention relates to a powered wheelchair (100, 200) for transporting a person comprising a seat frame (40) for supporting the person, a pair of opposing drive wheel assemblies (20, 30) configured to drive said powered wheelchair (100, 200) and connected to the seat frame (40), and a supporting wheel assembly (50) arranged spaced apart from the pair of opposing drive wheel assemblies (20, 30) and connected to the seat frame (40). The pair of opposing drive wheel assemblies (20, 30) comprising a first drive wheel assembly (20) and a second drive wheel assembly (30). The first drive wheel assembly (20) includes a first driving wheel (24) having a first rotation centre (R₁) and operatively connected to a first rotation mechanism (26) via a first linkage member (28), said first rotation mechanism (26) is operable to rotate said first drive wheel assembly about a first pivot point (P₁), wherein said first rotation centre is offset from said first pivot point. The supporting wheel assembly (50) includes a supporting rotatable wheel (54) having a third rotation centre (R₃) and operatively connected to a third rotation mechanism (56) via a third linkage member (58), said third rotation mechanism (56) is operable to rotate said supporting wheel assembly (50) about a third pivot point (P₃), wherein said third rotation centre (R₃) is offset from said third pivot point (P₃). The invention also relates to a method for operating a powered wheelchair.

### FIELD OF THE INVENTION

The invention relates to a powered wheelchair for transporting a person. Furthermore, the invention relates to a method for operating a powered wheelchair. Although the invention will be described in relation to an electric-powered wheelchair, the invention is not restricted to a wheelchair having this particular power source, but may also be used in other types of powered wheelchairs and/or power-assisted wheelchair.

### BACKGROUND OF THE INVENTION

Wheelchairs are important devices for people suffering from conditions which reduce their capability to walk, for example as a result of illness, injury, or disability. A wheelchair may increase the quality of life for millions of people suffering from such conditions.

More recently, powered wheelchairs have become a more common solution for facilitating motion for affected persons, in particular persons suffering from more severe conditions. One type of powered wheelchairs is an electrically powered wheelchair. The power to an electrically powered wheelchair can for instance be provided by an electric motor. By providing electrical power to drive the wheelchair, the quality of life for severely affected people is particularly improved since less manual operation is required. Hence, travelling longer distances is less exhausting with an electrically powered wheelchair. An electrical power source in a powered wheelchair may also be employed for additional advanced operations and functions of the wheelchair.

Over time, the operation of the powered wheelchair has continuously been further developed and for this type of wheelchairs it has often been an aim to improve the freedom of movement for the user of the wheelchair while maintaining a high level of safety during use.

Several attempts to achieve this have been carried out. In US 2002/0121394 A1, for example, there is disclosed a control system and method for controlling the operation of a transport device, such as a wheelchair. The transport device is considered as a self balancing human transport device in the sense that the wheelchair includes a moveable arm and a control unit to control movement of the arm in order to balance the transport device and to control movement of the ground contacting wheel so as to balance the transport device. In one specific example, the movable arm is connected to a rotatable cluster including a plurality of wheels. The cluster and the plurality of wheels are moved via an actuator allowing both the cluster to rotate and the plurality of wheels to move such that a center of gravity of the human transport device is located at a position vertically displaced between endpoints of the cluster. Thereby, the operation of this transport device can improve control of the location of the centre of gravity of the system to provide a more stable transport device.

In addition, powered wheelchairs may be designed for indoor, outdoor or indoor/outdoor use. A powered wheelchair for outdoor use may preferably have a considerable range, i.e. a large wheelbase to help with stability, whilst a typical powered wheelchair for indoor use often is narrow and short, to enable better manoeuvring around tight environments.

Despite the activity in the field, exemplified by the above-cited disclosure, there remains a need for an improved powered wheelchair which combines high performance and functionality with an acceptable level of safety for the user. In particular, there is a need for a solution of controlling a powered wheelchair having an increased freedom of operation, while ensuring a smooth travelling in various environments.

### SUMMARY OF THE INVENTION

In view of the above-mentioned and other drawbacks of the prior art, a general object of the present invention is to provide an improved and controllable powered wheelchair which allows for an adjustment of the wheelbase of the powered wheelchair. This and other objects, which will become apparent in the following, are accomplished by a powered wheelchair and a method of operating a powered wheelchair as defined in the accompanying independent claims. Preferred optional features are recited in the associated dependent claims.

According to a first aspect of the present invention, there is provided a powered wheelchair for transporting a person. The powered wheelchair comprises a seat frame for supporting the person, a pair of opposing drive wheel assemblies configured to drive said powered wheelchair and connected to the seat frame, and a supporting wheel assembly arranged spaced apart from the pair of drive wheel assemblies and connected to the seat frame. The pair of opposing drive wheel assemblies comprises a first drive wheel assembly and a second drive wheel assembly. The first drive wheel assembly includes a first driving wheel having a first rotation centre and operatively connected to a first rotation mechanism via a first linkage member. Thus, the first rotation mechanism is operable to rotate the first drive wheel assembly about a first pivot point. In addition, the first rotation centre is offset from the first pivot point. The supporting wheel assembly includes a supporting rotatable wheel having a third rotation centre and operatively connected to a third rotation mechanism via a third linkage member. Thus, the third rotation mechanism is operable to rotate the supporting wheel assembly about a third pivot point. In addition, the third rotation centre is offset from the third pivot point.

Hereby, the first drive wheel assembly and the supporting wheel assembly are configured to be independently operable, as is further described hereinafter.

More specifically, the first drive wheel assembly and the supporting wheel assembly are configured to be independently operable to adjust the wheelbase of the powered wheelchair.

Accordingly, by the principle of the present invention, it becomes possible to provide a powered wheelchair that is capable of transforming shape and wheelbase upon a rotation of any one of the rotation mechanisms. More specifically, due to the arrangement that each one of the wheel assemblies are separately connected to corresponding rotation mechanisms, it becomes possible to independently operate each one of the wheel assemblies in order to adjust the wheelbase of the powered wheelchair.

To this end, the powered wheelchair is capable of providing an improved control function while enabling a transformation between various operational modes that alleviates the drawbacks of many conventional powered wheelchairs.

In addition, since the pair of opposing driving wheel assemblies and the supporting wheel assembly are connected to the seat frame, it becomes possible to adjust the position of the seat frame by adjusting the position of any one of the wheel assemblies. The position of a drive wheel assembly is adjusted by pivoting said drive wheel assembly about the corresponding pivot point by operating the rotation mechanism.

Advantages of the powered wheelchair according to the present invention will be described in more detail throughout the application text, but are also briefly summarized by the following:
The powered wheelchair allows for a transformation between various modes and thereby improves the versatility of the wheelchair. More specifically, by the arrangement of the powered wheelchair the transformation between various modes can be carried out without added complexity in mechanics.
The powered wheelchair allows for improved curb and obstacle climbing by ensuring that the wheel assemblies can be independently controlled via operation of corresponding rotation mechanism.
The powered wheelchair may allow for an inclinometer based ride control so that the powered wheelchair can be operated in rough terrain in a safe and comfortable manner.
The powered wheelchair may allow for a significant reduction in weight compared to many of the existing powered wheelchair since the more traditional chassis can be eliminated. This may further have a positive impact on the costs of manufacturing powered wheelchairs.
The powered wheelchair may allow for advanced control functions, such as height- and tilt control of the seat frame and/or levelled seat position regardless of terrain.
By facilitating the adjustment of the wheelbase and/or the position of the seat frame, the powered wheelchair is capable of being adjusted so that a seat cushion of a seat frame of the wheelchair can maintain a user-friendly position when an obstacle is being traversed. A user-friendly position often corresponds to an essentially horizontal level of the seat cushion of the seat frame.
The wheel assemblies that are independently controlled via operation of the corresponding rotation mechanisms to adjust the wheelbase can also be used to obtain an upright position (also referred to as the stand-up mode) where the user in effect is standing up.

By the provisions that the first drive wheel assembly is operatively connected to the first rotation mechanism via the first linkage member, the first rotation mechanism is operable to rotate the drive wheel assembly about the first pivot point, and that the supporting wheel assembly is operatively connected to the third rotation mechanism via the third linkage member, the third rotation mechanism is operable to rotate the supporting wheel assembly about the third pivot point, it becomes possible to operate and control the rotation of the first drive assembly independently of the supporting wheel assembly. Analogously, it becomes possible to operate and control the rotation of the supporting wheel assembly independently of the first drive assembly.

In the context of the present invention, the term “operatively connected” typically refers to a connection between the wheel and the rotation mechanism by means of the linkage member so that the position of the wheel (e.g. the first driving wheel) is changed upon rotation of the corresponding rotation mechanism (e.g. the first rotation mechanism). In other words, a driving wheel (or supporting rotatable wheel) is operatively connected to a rotation mechanism via a linkage member so that the rotation mechanism is capable of rotating the wheel assembly about its pivot point.

In at least an exemplary embodiment when the first rotation mechanism is configured to rotate both the first drive wheel assembly and the second drive wheel assembly so that the first drive wheel assembly and the second drive wheel assembly rotate about the same pivot point, i.e. the first pivot point, a central wheelbase distance, as defined by the distance between a common axis of rotation of the first and second rotation centres and the third rotation centre of the supporting wheel assembly, can be adjusted by pivoting the first drive wheel assembly and the second drive wheel assembly about the first common axis of rotation and/or the supporting wheel assembly about the third pivot point.

However, in at least another exemplary embodiment relating to a powered wheelchair in which the three wheel assemblies are independently operable relative to each other, as described in further details below, any one of a first wheelbase, a second wheelbase and the central wheelbase can be adjusted by pivoting any one of the first drive wheel assembly, the second drive wheel assembly and the supporting wheel assembly about corresponding pivot points.

Typically, the wheelbase is adjusted via the rotation mechanism(s) to obtain a set of predetermined mode of the powered wheelchair, as will be described further hereinafter.

Typically, the first rotation mechanism and the third rotation mechanism may be independently operable to adjust a position of the seat frame. As mentioned above, the position of the seat frame is adjusted upon an adjustment of the wheelbase. Accordingly, it should be readily understood that the first rotation mechanism and the third rotation mechanism may be independently operable to adjust the wheelbase. In the context of the present invention, it is to be noted that since the wheels of the powered wheelchair are typically in contact with a ground surface when any one of the rotation mechanisms are operated, at least during normal use of the wheelchair, an adjustment of the position of any one of the wheel assemblies result in that the position (e.g. height) of the seat frame of the wheelchair is changed since the lengths of the linkage members (essentially defining the distance from the wheel to the seat frame) are constant.

According to at least one exemplary embodiment, the second drive wheel assembly includes a second driving wheel having a second rotation centre and operatively connected to said first rotation mechanism via a second linkage member, said first rotation mechanism is operable to rotate the second drive wheel assembly about the first pivot point, wherein said second rotation centre is offset from said first pivot point.

In this manner, it becomes possible to provide a powered wheelchair capable of adjusting its wheelbase based on an operation of any one of the first rotation mechanism and third rotation mechanism independently, whilst the first rotation mechanism is configured to rotate both the first drive wheel assembly and the second drive wheel assembly. In this arrangement, the first drive wheel assembly and the second drive wheel assembly rotate about the same pivot point, i.e. the first pivot point.

However, in another exemplary embodiment, the second driving wheel may be operatively connected to the first rotation mechanism via the second linkage member so that the first rotation mechanism is operable to rotate the second drive wheel assembly about a second pivot point. In this exemplary embodiment, the second pivot point is offset from the first pivot point whilst being located on a common axis of rotation. An offset between the first pivot point and the second pivot point may be realised by having an intermediate linkage member extending from the rotation mechanism along the axis of rotation, which is connected to the first and second linkage members.

According to at least another exemplary embodiment, the second drive wheel assembly includes a second driving wheel having a second rotation centre and operatively connected to a second rotation mechanism via a second linkage member, said second rotation mechanism is operable to rotate the second drive wheel assembly about a second pivot point, wherein said second rotation centre is offset from said second pivot point.

Hereby, the first drive wheel assembly, the second drive wheel assembly and the supporting wheel assembly are configured to be independently operable, as is further described hereinafter. More specifically, the first drive wheel assembly, the second drive wheel assembly and the supporting wheel assembly are configured to be independently operable to adjust the wheelbase of the powered wheelchair. Accordingly, by this arrangement, there is provided a powered wheelchair having three different wheel assemblies being independently operable relative to each other.

Typically, the first rotation mechanism, the second rotation mechanism and the third rotation mechanism may be independently operable to adjust a position of the seat frame.

Besides the advantages relating to the above arrangement including a first rotation mechanism and a third rotation mechanism, this exemplary embodiment provides the further advantages of allowing the rotation of the first drive assembly to be operated and controlled independently of the supporting wheel assembly, allowing the rotation of the second drive assembly to be operated and controlled independently of the supporting wheel assembly, while allowing the rotation of the first drive assembly to be operated and controlled independently of the second wheel assembly and allowing the rotation of the supporting wheel assembly to be operated and controlled independently of the first and second wheel assemblies. Analogously, it becomes possible to operate and control the rotation of the second wheel assembly independently of the first drive assembly.

More specifically, by this type of powered wheelchair arrangement, it becomes possible to adjust the position of the first wheel assembly relative to the position of the second wheel assembly so that an obstacle such as a pavement edge can be overcome while maintaining a levelled position of the seat frame. Other examples of possible obstacles may include door thresholds and changing pavement heights. Thus, the powered wheelchair is capable of being adjusted so that a seat cushion of a seat frame of the wheelchair can maintain a user-friendly position when an obstacle is being traversed. Hereby, the powered wheelchair is capable of traversing obstacles and rough terrain. In other words, the inventive concept is considered to have an improved ability to climb and descend obstacles.

In the context of the inventive concept, a “first wheelbase” distance, as defined by the distance between the first rotation centre of the first driving wheel and the third rotation centre of the supporting rotatable wheel, can be adjusted by pivoting any one of the first drive wheel assembly and the supporting wheel assembly about its corresponding pivot point, i.e. by pivoting the first drive wheel assembly about the first pivot point and/or the supporting wheel assembly about the third pivot point. As an example, the wheelbase will be shortened if the first drive wheel assembly is rotated about the first pivot point in a direction towards the supporting rotatable wheel, while the supporting wheel assembly remains its position or rotates (about the third pivot point) in a direction towards the first drive wheel assembly. Analogously, the wheelbase will be increased if the first drive wheel assembly is rotated about the first pivot point in a direction away from the supporting rotatable wheel, while the supporting wheel assembly remains its position or rotates in a direction away from the first drive wheel assembly. It should be readily appreciated that the above example is only one of many examples of pivoting a wheel assembly about a pivot point and there are several other different possibilities to adjust the wheelbase of the powered wheelchair.

Similar to the situation with the first wheelbase distance, a “second wheelbase” distance, as defined by the distance between the second rotation centre of the second driving wheel and the third rotation centre of the supporting rotatable wheel, can be adjusted by pivoting any one of the second drive wheel assembly and the supporting wheel assembly about corresponding pivot points, i.e. by pivoting the second drive wheel assembly about the second pivot point and/or the supporting wheel assembly about the third pivot point. As an example, the wheelbase will be shortened if the second drive wheel assembly is rotated about the second pivot point in a direction towards the supporting rotatable wheel, while the supporting wheel assembly remains its position or rotates (about the third pivot point) in a direction towards the second drive wheel assembly. Analogously, the wheelbase will be increased if the second drive wheel assembly is rotated about the second pivot point in a direction away from the supporting rotatable wheel, while the supporting wheel assembly remains its position or rotates in a direction away from the second drive wheel assembly. It should be readily appreciated that the above example is only one of many examples of pivoting the wheel assembly about a pivot point and that there are several additional different possibilities to adjust the wheelbase of the powered wheelchair.

Accordingly, this type of powered wheelchair arrangement allows for adjusting any one of the first wheelbase and the second wheelbase as well as the central wheelbase. The central wheelbase may be adjusted by initially adjust the first wheelbase and thereafter the second wheelbase. However, it should also be readily appreciated that the first drive wheel assembly and the second drive wheel assembly may be simultaneously operated in an aligned manner via the first rotation mechanism and the second rotation mechanism, respectively. In this manner, the “central wheelbase” distance, here defined as the distance between a common axis of rotation of the first and second rotation centres and the third rotation centre of the supporting wheel assembly, can be adjusted by pivoting any one of the first drive wheel assembly, the second drive wheel assembly and the supporting wheel assembly about corresponding pivot points.

As mentioned above, the position of the seat frame can be adjusted upon an adjustment of the wheelbase (first, second and/or central wheelbase). Accordingly, it should be readily understood that the first rotation mechanism, the second rotation mechanism and the third rotation mechanism may be independently operable to adjust the wheelbase. In addition, the wheelbase can typically be adjusted via any one of the rotation mechanisms to obtain as set of predetermined modes of the powered wheelchair, as will be further described hereinafter.

According to at least one exemplary embodiment, the first rotation mechanism, the second rotation mechanism and the third rotation mechanism are independently operable to control the height of the seat frame. According to at least one exemplary embodiment, the first rotation mechanism, the second rotation mechanism and the third rotation mechanism are independently operable to control the tilt angles of the seat frame.

As an example, the rotation mechanism(s) can be operated to lateral tilt at least a part of the seat frame about a tilt axis of the seat frame. In addition, or alternatively, the rotation mechanism(s) can be operated to tilt at least a part of the seat frame forwardly and/or rearward, as seen in a travelling direction of the powered wheelchair. In the context of the present invention, the travelling direction typically refers to the normal driving direction of the wheelchair.

The lateral tilt may be effectuated by pivoting at least one of the first drive wheel assembly and the second drive wheel assembly. Typically, the first drive wheel assembly and the second drive wheel assembly cooperate to tilt the seat frame in a smooth manner.

In addition, or alternatively, the first rotation mechanism, the second rotation mechanism and the third rotation mechanism may be independently operable to lift at least a part of the seat frame in an essentially vertical direction, typically corresponding to a direction perpendicular to the driving direction.

As mentioned above, any one of the first rotation mechanism, the second rotation mechanism and the third rotation mechanism may be independently operable to adjust the wheelbase of the powered wheelchair. In a general definition, the wheelbase herein may refer to any one of the first, second and/or central wheelbases.

The wheelbase can be adjusted so that the powered wheelchair is capable of being transformed between several different modes. Typically, the powered wheelchair may be operated between an indoor mode, an outdoor mode and a stand-up mode. Thus, the powered wheelchair may according to at least one exemplary embodiment be transformable into a set of modes including an indoor mode, an outdoor mode and a stand-up mode by an adjustment of the wheelbase of the powered wheelchair by means of any one of the first rotation mechanism, the second rotation mechanism and the third rotation mechanism. As mentioned above, a rotation mechanism is configured to adjust the position of a corresponding wheel assembly so that the wheelbase distance is adjusted accordingly.

The indoor mode refers to a powered wheelchair having a relatively short wheelbase, the outdoor mode refers to powered wheelchair having a relatively long wheelbase, while the stand-up mode refers to a mode in which the wheelchair is a “standing wheelchair” in the sense that seat frame supports the user in a standing position. Accordingly, the powered wheelchair can be operated so that the user is allowed to sit or stand in the wheelchair as they wish.

Accordingly, the wheelbase may be shortened such that the powered wheelchair is in an indoor mode, where the pair of the opposing drive wheel assemblies is positioned in a mid section of the powered wheelchair, as seen in the travelling direction. The travelling direction here refers to the normal forward direction of the powered wheelchair, typically corresponding to the driving direction. A powered wheelchair having a short wheelbase is compact and will therefore fit into small indoor spaces. Also manoeuvring of the wheelchair is enhanced since the two wheels (i.e. the first driving wheel and the second driving wheel) are basically centred in the vehicle, which allows for on the spot rotation.

In addition, or alternatively, the wheelbase may be increased such that the powered wheelchair is in an outdoor mode, where the pair of the opposing drive wheel assemblies is positioned in front of the seat frame of the powered wheelchair, as seen in the travelling direction. This configuration has the advantage of getting front drive wheels in front of the leg or foot rest assembly that are normally used, in order to for example climb up a curb without collision with foot rest.

According to at least one exemplary embodiment, the seat frame may include a first support section pivotably connected to a second support section, wherein the wheelbase is adjusted such that seat frame is positioned in a substantially vertical orientation (i.e. an up-right position, typically referred to as the stand-up mode). In this manner, the powered wheelchair transforms into a stand-up mode. In other words, the stand-up mode here refers to a mode when the seat frame is in an essentially vertical orientation, as seen relative to the ground plane. As an example, the first support section is the back support section (back rest), while the second support section is the seat cushion support section.

According to at least one exemplary embodiment, the first drive wheel assembly and the second drive wheel assembly are operable in synchronism. In this manner, the pair of opposing drive assemblies can be adjusted synchronously in order to directly adjust the central wheelbase of the powered wheelchair. This means that the first and the second drive assemblies are adjusted in synchronism at substantially the same speed. This type of operation can be desirable in some situations compared to the alternative of a stepwise adjustment of the first wheelbase and the second wheelbase.

According to at least one exemplary embodiment, the powered wheelchair may further comprise an inclinometer, which e.g. can be attached to any part of the seat frame. Typically, the inclinometer is configured to operate any one of the first rotation mechanism, the second rotation mechanism and the third rotation mechanism based on a regulatory algorithm to maintain seat tilt angles and riding height, respectively, at user definable set-points. The inclinometer may typically consist of a 3-axis accelerometer and a 3-axis gyro connected to the control system (control unit) of the powered wheelchair. By interpreting the signals from the inclinometer, all directions of rotation and all directions of acceleration of the seat frame can be determined, and thereafter used as input to a regulatory system that maintains for example the seat tilt angles in the horizontal plane at a preset value by controlling the rotation mechanisms. Another example of use is the rotation around the vertical centre of the powered wheelchair. In this example, the inclinometer can be used to stabilize the steering control algorithm of the wheelchair.

Further use of the accelerometer signals is to detect slipping of drive wheels. That is, a simple traction control system can be obtained by analysing drive wheel angular acceleration and compare this to real acceleration of seat frame.

According to at least one exemplary embodiment, the powered wheelchair may therefore further comprise an accelerometer to operate any one of the first rotation mechanism, the second rotation mechanism and the third rotation mechanism. In addition, or alternatively, the powered wheelchair may further comprise a gyro to operate any one of the first rotation mechanism, the second rotation mechanism and the third rotation mechanism. In this manner, the powered wheelchair can be controlled (or operated) such that a levelled position of the seat frame is maintained regardless of terrain.

According to at least one exemplary embodiment, the powered wheelchair may further comprise a control unit for operating any one of the first rotation mechanism, the second rotation mechanism and the third rotation mechanism.

Optionally, although not strictly required, the control unit may be configured to independently operate any one of the first rotation mechanism, the second rotation mechanism and the third rotation mechanism, as mentioned above. In addition, or alternatively, the control unit may be configured to adjust the wheelbase of the powered wheelchair based on an operation of any one of the first rotary actuator, second rotary actuator and third rotary actuator.

In addition, or alternatively, the control unit may be configured to adjust a tilt angle of a part of the seat frame by operating any one of the first rotary actuator, second rotary actuator and third rotary actuator.

In addition, or alternatively, the control unit may be configured to adjust the height of a part of the seat frame by operating any one of the first rotary actuator, second rotary actuator and third rotary actuator.

In addition, or alternatively, the control unit may be configured to maintain a tilt angle of a part of the seat frame at a predetermined set point.

In addition, or alternatively, the control unit may be configured to maintain the height of a part of the seat frame at a predetermined set point.

In addition, or alternatively, the control unit may be configured to gather data indicative of the prevailing terrain topology upon movement of the powered wheelchair.

In addition, or alternatively, the control unit may be configured to evaluate said data indicative of the prevailing terrain topology to adjust the characteristics of the control unit relating to control of drive and seat adjustments.

For example, the data indicative of prevailing terrain topology can be used to set a limit of maximum speed in uphill driving. In addition, or alternatively, the data indicative of prevailing terrain topology can be used to turn off the adjustment of the seat frame in situations when the terrain topology is sufficiently flat for a smooth driving of the powered wheelchair in order to save battery.

In addition, or alternatively, the control unit may be configured to operate any one of the first rotary actuator, the second rotary actuator and the third rotary actuator based on said evaluated data to adjust the wheelbase of the powered wheelchair.

The term “control unit” may refer to a processing circuitry and/or may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

According to at least one exemplary embodiment, the control unit includes a user interface for operating the powered wheelchair and the rotation mechanism(s). As an example, the user interface may be provided by a conventional joystick arranged on the powered wheelchair and easily accessible by the user of the wheelchair. However, the user interface may also be provided in the form of a wireless device, such as cellular phone etc.

For users who cannot manage a manual joystick, head-switches, chin-operated joysticks, sip-and-puff or other specialist controls may allow independent operation of the wheelchair.

According to at least one exemplary embodiment, the pair of drive wheel assemblies is a pair of front wheel assemblies. In other words, the powered wheelchair includes a first front wheel assembly and a second front wheel assembly.

According to at least one exemplary embodiment, the powered wheelchair is powered by an electric motor. As an example, the electric motor may be provided in the form of a hub wheel motor.

According to at least one exemplary embodiment, the supporting wheel assembly is a rear wheel assembly. In other words, the powered wheelchair includes a rear supporting wheel assembly.

Typically, the supporting wheel assembly may be adapted to turn in a way that aligns with the drive direction of the wheelchair.

According to at least one exemplary embodiment, the supporting wheel assembly is a caster wheel arrangement. A caster wheel arrangement is a wheel arrangement that is configured to turn in a way that aligns with the drive direction of the wheelchair. There are several different types of commercially available caster wheel arrangements. Caster wheel arrangements are also used in a variety of devices, for example in traditional shopping carts or on mobile office chairs. A caster wheel arrangement has a freedom of rotation such that the wheel is adapted to turn in a way that aligns with the drive direction of the wheelchair (or another device where the caster wheel is mounted) on the ground. For electrical wheelchairs, this is important for efficient turning control of the wheelchair.

According to at least one exemplary embodiment, the supporting rotatable wheel is a first supporting rotatable wheel. In this exemplary embodiment, the supporting wheel assembly further includes a second supporting rotatable wheel.

In all exemplary embodiments of the present inventive concept, the rotation mechanism may be provided in the form of a rotary actuator. One example of a rotary actuator is a servo. Rotary actuators are commercially available and can be provided in many sizes and shapes. One example of a rotary actuator suitable for the powered wheelchair is DC-motor with a planetary gearbox.

Typically, the rotation mechanism may have a mounting side for mounting the rotation mechanism to another component. As an example, the rotation mechanism may be directly mounted to the seat frame of the powered wheelchair via the mounting side so that the rotation mechanism is directly connected to the seat frame. However, one of the rotation mechanisms, e.g. the first rotation mechanism, may also be indirectly connected to the seat frame e.g. by having the first rotation mechanism mounted on the third linkage member, which itself is mounted to the seat frame by the third rotation mechanism. Accordingly, the term “connected” may encompass both directly connected and indirectly connected configurations between the rotation mechanism and the seat frame.

The inventive concept can be used for various types of powered wheelchair. According to at least one exemplary embodiment, the powered wheelchair is an electrically powered wheelchair. An electrically powered wheelchair is a wheelchair that is moved via the means of an electric motor, rather than manual power. Typically, the electrically powered wheelchair further includes navigational controls, usually a small joystick mounted on an armrest of the seat frame. For users who cannot manage a manual joystick, head-switches, chin-operated joysticks, sip-and-puff or other specialist controls may allow independent operation of the wheelchair.

According to a second aspect of the present invention, there is provided a method for operating a powered wheelchair according to the first aspect and/or any one of the exemplary embodiments of the present inventive concept as mentioned above.

Effects and features of this second aspect of the present inventive concept are largely analogous to those described above in relation to the first aspect of the present invention.

According to at least one exemplary embodiment, the method comprises at least three predetermined modes, such as an indoor mode, an outdoor mode and a stand-up mode. The powered wheelchair is transformed into any one of the predetermined modes by operating any one of the first rotation mechanism, the second rotation mechanism and the third rotation mechanism to adjust the wheelbase of the powered wheelchair.

According to at least one exemplary embodiment, the method comprises the step of independently operating any one of the first rotation mechanism, the second rotation mechanism and the third rotation mechanism to adjust the wheelbase of the powered wheelchair.

According to at least one exemplary embodiment, the wheelbase is shortened such that the powered wheelchair is transformed into the indoor mode, where the pair of the opposing drive wheel assemblies are positioned in a mid section of the powered wheelchair, as seen in a longitudinal direction X of the powered wheelchair.

According to at least one exemplary embodiment , the wheelbase is increased such that the powered wheelchair is transformed into the outdoor mode, where the pair of the opposing drive wheel assemblies are positioned in front of the seat frame of the powered wheelchair, as seen in a longitudinal direction X of the powered wheelchair.

According to at least one exemplary embodiment, the seat frame includes a first support section pivotably connected to a second support section, wherein the wheelbase is adjusted such that the seat frame is positioned in a substantially vertical orientation. That is, the first support section and the second support section which define the seat frame are both positioned in a substantially vertical direction.

Further features of, and advantages with, the present inventive concept will become apparent when studying the appended claims and the following description. The skilled person may realize that different features of the present inventive concept may be combined to create embodiments other than those described in the following, without departing from the scope of the present invention. For example, the above description of the different advantages of the present invention is primarily described in relation to an electrically powered wheelchair, however, the various embodiments of the inventive concept are of course also applicable when the powered wheelchair is driven by another type of power, such as a combustion engine.

In addition, the above description of the different advantages of the present invention is primarily described in relation to a powered wheelchair in which the driving assemblies are arranged in front of the rear supporting wheel assembly, as seen in the travelling direction of the wheelchair, however, the various embodiments of the inventive concept are of course also applicable to a powered wheelchair in which the driving assemblies are arranged as rear driving assemblies and the supporting wheel assembly is a front supporting wheel assembly, as seen in the travelling direction of the wheelchair.

### BRIEF DESCRIPTION OF THE DRAWINGS

The various aspects of the invention, including its particular features and advantages, will be readily understood from the following illustrative and non-limiting detailed description and the accompanying drawings, in which:

FIG. 1a illustrates schematically at least an exemplary embodiment of the present inventive concept;

FIG. 1b is a bottom view of the exemplary embodiment of the present inventive concept in FIG. 1a;

FIG. 1c illustrates a detailed view of the exemplary embodiment of the present inventive concept in FIG. 1a;

FIG. 1d illustrates another detailed view of the exemplary embodiment of the present inventive concept in FIG. 1a;

FIG. 1e is a side-view illustrating further details of the exemplary embodiment of the powered wheelchair in FIG. 1a;

FIG. 1f illustrates another detailed view of another exemplary embodiment of the present inventive concept in FIG. 1a;

FIG. 2 is a perspective view illustrating an exemplary embodiment of the powered wheelchair in an outdoor mode, in which the powered wheelchair has a long wheelbase;

FIG. 3 is a perspective view illustrating an exemplary embodiment of the powered wheelchair in an indoor mode, in which the powered wheelchair has a short wheelbase;

FIG. 4 is a perspective view illustrating an exemplary embodiment of the powered wheelchair in a stand-up mode, in which the seat frame of the powered wheelchair is in an essentially vertical orientation;

FIG. 5 illustrates a situation when an obstacle is to be traversed by a powered wheelchair according to an exemplary embodiment of the present invention;

FIG. 6 illustrates schematically at least another exemplary embodiment of the present inventive concept.

### DETAILED DESCRIPTION OF EXEMPLARY EMBODIMENTS OF THE INVENTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout. Note that the directions in the following description are used for facilitating the understanding of a positional relation between components in the figures and that the directions may be different in other driving directions of the powered wheelchair. The same is applied to other exemplary embodiments described below.

Although the following description has been made to an electric-powered wheelchair, the present inventive concept may as well be implemented in other powered wheelchair. An electric-powered wheelchair refers to a wheelchair that is typically moved via the means of an electric motor, as further described herein.

The term “front” here corresponds to the front direction of the powered wheelchair, while the term “rear” here corresponds to the rear direction of the powered wheelchair. Analogously, when a part of the powered wheelchair is denoted with the term “front” or “rear”, a reference may typically be made to the travelling direction (sometime also denoted the driving direction) when the wheelchair is driven in a forward direction to cause the wheelchair to move forwardly. However, it should be readily appreciated that the wheelchair may be driven in a reverse mode so that the wheelchair is driven in a direction (rearward direction) opposite to the normal travelling direction.

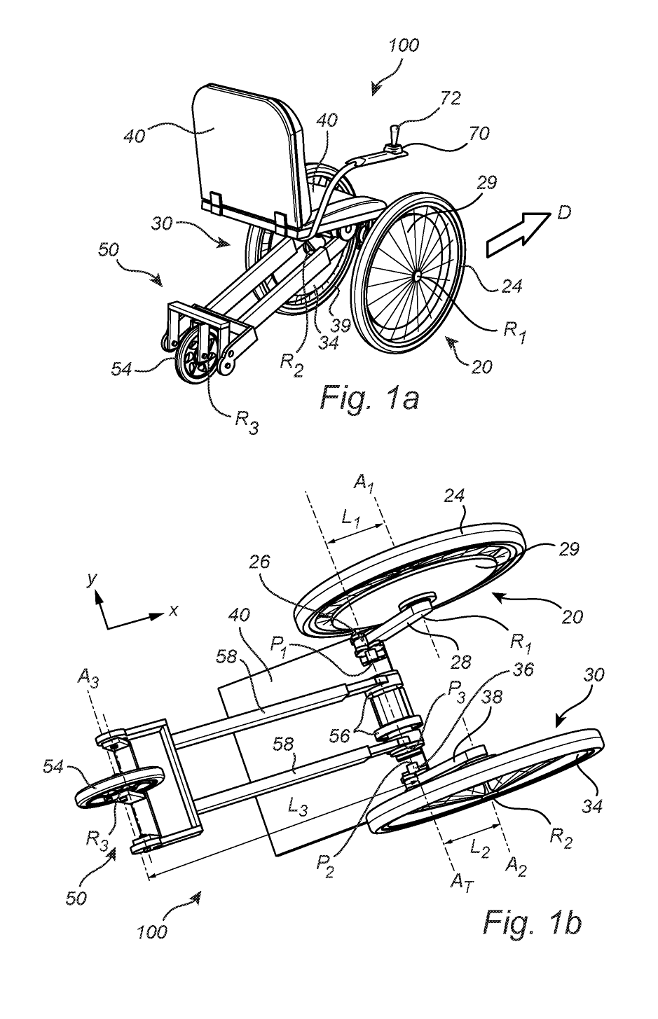

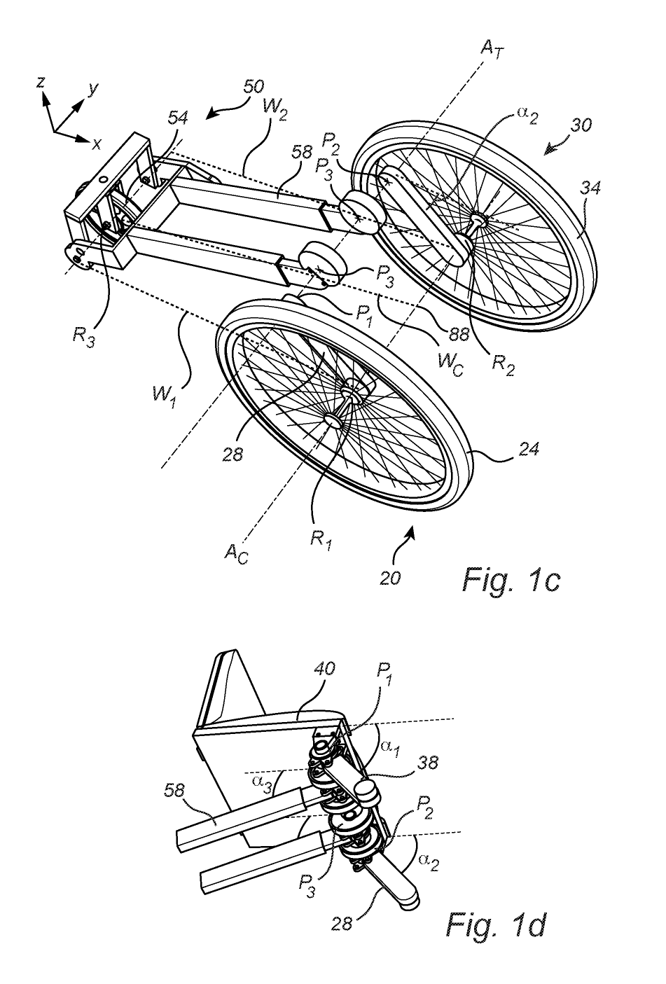

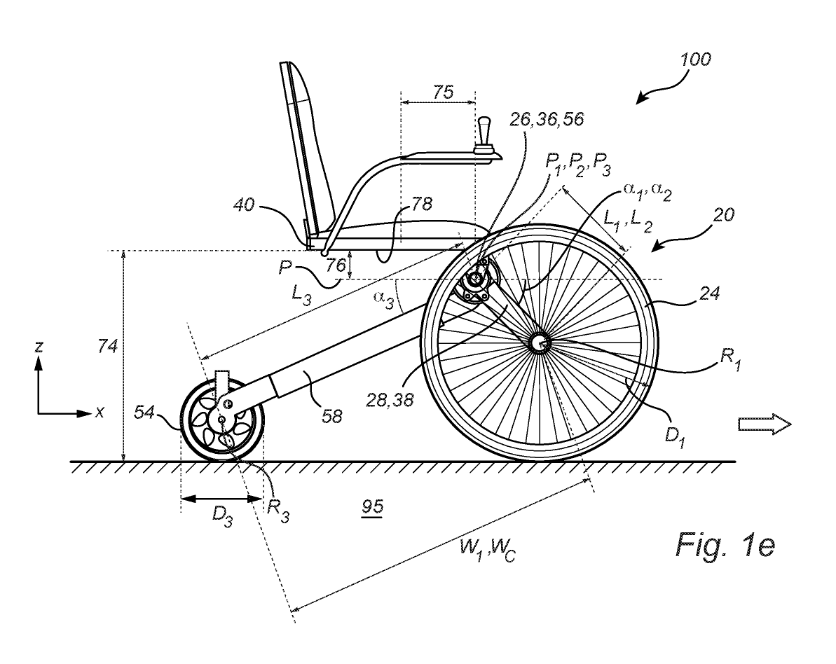

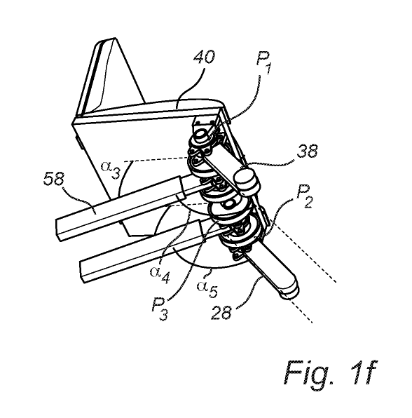

Referring now to the drawings and to FIGS. 1a and 1b in particular, there is depicted an example of a powered wheelchair according to the present inventive concept. FIG. 1a illustrates schematically at least an exemplary embodiment of the present inventive concept. It should be noted that FIG. 1a is a general schematic representation of a powered wheelchair 100 for transporting a person and is merely intended to show an underlying principle of the inventive concept.

In this exemplary embodiment, the powered wheelchair 100 is illustrated as having a seat frame 40 for supporting the person, a pair of opposing drive wheel assemblies 20, 30 configured to drive said powered wheelchair 100 and connected to the seat frame 40. The powered wheelchair further includes a supporting wheel assembly 50 arranged spaced apart from the pair of drive wheel assemblies 20, 30 and connected to the seat frame 40. The pair of opposing drive wheel assemblies 20, 30 includes a first drive wheel assembly 20 and a second drive wheel assembly 30, which will be described in more detail hereinafter with respect to FIG. 1b. The first drive assembly and the second drive assembly are arranged opposite each other as seen in a transverse direction Y of the powered wheelchair. Hence, the first drive assembly 20 and the second drive assembly 30 are spaced apart from each other, as illustrated in FIGS. 1a and 1b.

In this exemplary embodiment, the wheel assembly 50 is further arranged spaced apart from the pair of opposing wheel assemblies 20, 30 as seen in the transverse direction Y of the powered wheelchair 100, and as illustrated in FIG. 1b. In addition, or alternatively, the wheel assembly 50 may be arranged spaced apart from the pair of opposing wheel assemblies 20, 30 as seen in a longitudinal direction X of the powered wheelchair 100.

Turning now again to FIGS. 1a and 1b, there is illustrated a powered wheelchair 100 according to an exemplary embodiment of the inventive concept. As will be further described in detail herein, the first drive wheel assembly 20 includes a first driving wheel 24 having a first rotation centre R₁. In addition, the first driving wheel 24 is operatively connected to a first rotation mechanism 26 via a first linkage member 28, as shown in FIG. 1b. In other words, the first drive assembly comprises the first driving wheel 24, the first rotation mechanism 26 and the first linkage member 28. Analogously, the second drive wheel assembly 30 includes a second driving wheel 34 having a second rotation centre R₂. In addition, the second driving wheel 34 is operatively connected to a second rotation mechanism 36 via a second linkage member 38. In other words, the second drive assembly comprises the second driving wheel 34, the second rotation mechanism 36 and the second linkage member 38. Analogously, the supporting wheel assembly 50 includes a supporting rotatable wheel 54 having a third rotation centre R₃. In addition, the supporting rotatable wheel 54 is operatively connected to a third rotation mechanism 56 via a third linkage member 58. In other words, the supporting wheel assembly comprises the supporting rotatable wheel 54, the third rotation mechanism 56 and the third linkage member 58.

The first driving wheel 24 may further include an outer rim portion having a ground-facing surface for being in contact with the ground surface during use of the powered wheelchair. The rim portion may for instance be a circular metal structure around which a wheel tire is fitted. Analogously, the second driving wheel 34 may further include an outer rim portion having a ground-facing surface for being in contact with the ground surface during use of the wheelchair powered. Analogously, the supporting rotatable wheel 54 may further include an outer rim portion having a ground-facing surface for being in contact with the ground surface during use of the wheelchair powered.

The powered wheelchair 100 may be powered by an electric motor configured for driving the powered wheelchair via the pair of opposing drive wheel assemblies 20, 30. As an example, the electric motor may be arranged within at least one of the driving wheels, e.g. in the form of a hub motor. Typically, each one of the first driving wheel 24 and the second driving wheel 34 may include a wheel hub motor 29, 39, respectively. The wheel hub motor (also called wheel motor, wheel hub drive, hub motor or in-wheel motor) is an electric motor that is incorporated into the hub of a wheel and drives it directly. A wheel hub motor is beneficial in the sense that it may eliminate mechanical transmission including gearboxes, differentials, drive shafts and axles. Thereby, a significant weight and manufacturing cost saving may be realized.

Accordingly, the first drive assembly 20 here includes a first wheel hub motor 29 configured to provide driving power to the powered wheelchair. Analogously, the second drive assembly 30 here includes a second wheel hub motor 39 configured to provide driving power to the powered wheelchair.

As shown in FIGS. 1a and 1b, the supporting wheel assembly here is a rear supporting wheel assembly. In other words, the powered wheelchair includes a rear supporting wheel assembly 50. It should thus be readily appreciated that throughout this description the component supporting wheel assembly may sometimes be referred to as the rear supporting wheel assembly without departing from the scope of the invention.

Further, the pair of opposing drive wheel assemblies is here a pair of opposing front drive wheel assemblies. In other words, the powered wheelchair includes a first front wheel assembly 20 and a second front wheel assembly 30. It should thus be readily appreciated that throughout this description the component first drive wheel assembly may sometimes be referred to as the first front drive wheel assembly without departing from the scope of the invention. In addition, it should be readily appreciated that throughout this description the component second drive wheel assembly may sometimes be referred to as the second front drive wheel assembly without departing from the scope of the invention. Typically, but not strictly necessary, the wheel diameter of the rear supporting rotatable wheel 54 is less than the wheel diameters of the front driving wheels 24, 34. As an example, the diameter of the rear supporting rotatable wheel is about 20 cm, and the diameter of a front driving wheel is about 50 cm.

Optionally, although not strictly necessarily, the powered wheelchair may include a leg or foot rest assembly as well as arm rests.

The powered wheelchair may further be provided with a control unit 70 for operating the powered wheelchair, as will be further described hereinafter. In order to facilitate the operation of the powered wheelchair, the control unit 70 may include a user interface, such as a joystick 72.

The control unit 70 may for example be arranged under the seat frame 40 or, as illustrated in FIG. 1a, adjacent to the user interface 72.

As illustrated in FIG. 1b, which is a bottom view of the exemplary embodiment of the present inventive concept in FIG. 1a, the first drive wheel assembly 20 includes the first driving wheel 24 having the first rotation centre R₁. The first rotation centre R₁here corresponds to a first axis of rotation A₁ of the first driving wheel 24. The first driving wheel 24 is operatively connected to the first rotation mechanism 26 via a first linkage member 28. In other words, the first drive assembly comprises the first driving wheel 24, the first rotation mechanism 26 and the first linkage member 28. Moreover, the first rotation mechanism 26 is operable to rotate the first drive wheel assembly 20 about the first pivot point P₁. Since the first driving wheel 24 is distanced from the rotation mechanism 26 by the first linkage member 28, the first rotation centre R₁is offset from the first pivot point P₁.

Further, the first linkage member 28 is connected to the first driving wheel 24 in a manner that allows the first driving wheel 24 to rotate in a rolling fashion around the first rotation centre R₁. Typically, the first rotation centre R₁corresponds to the first axis of rotation A₁. Hereby, the first driving wheel 24 is allowed to rotate around the first rotation centre R₁upon a driving motion of the first wheel hub motor 29. The first linkage member 28 may be connected to the first driving wheel 24 via e.g. a bolt or similar. The connection may further include a bearing to support the rotational motion of the first driving wheel 24.

In this exemplary embodiment, the first rotation mechanism 26 is a rotary actuator. However, other options are conceivable as long as the rotation mechanism is capable to rotate the drive wheel assembly about the pivot point.

As illustrated in FIGS. 1a and 1b, the first linkage member 28 here is rotatably connected to the first driving wheel 24 at the first rotation centre R₁ (or the first axis of rotation) on one side of the wheel 24. Alternatively, the first linkage member 28 may be rotatably connected at the first axis of rotation on both sides of the wheel, as long as the wheel is allowed to rotate about its rotation centre. If the first linkage member is connected on both sides of the wheel, the first linkage member may be formed as a fork reaching to both sides of the wheel at the first axis of rotation.

Analogous to the configuration of the first drive wheel assembly, the supporting wheel assembly 50 includes the supporting rotatable wheel 54 having the third rotation centre R₃. The third rotation centre R₃ here corresponds to a third axis of rotation A₃ of the supporting rotatable wheel 54. The supporting rotatable wheel 54 is operatively connected to the third rotation mechanism 56 via the third linkage member 58. In other words, the supporting wheel assembly 50 comprises the supporting rotatable wheel 54, the third rotation mechanism 56 and the third linkage member 58. Moreover, the third rotation mechanism 56 is operable to rotate the supporting wheel assembly 50 about the third pivot point P₃. Since the supporting rotatable wheel 54 is distanced from the third rotation mechanism 56 by the third linkage member 58, the third rotation centre R₃ is offset from the third pivot point P₃.

Further, the third linkage member 58 is connected to the supporting rotatable wheel 54 in a manner that allows the supporting rotatable wheel 54 to rotate in a rolling fashion around the third rotation centre R₃. Typically, the third rotation centre R₃ corresponds to the third axis of rotation A₃. Hereby, the supporting rotatable wheel 54 is allowed to rotate around the third rotation centre R₃. It should be noted that the supporting wheel assembly 50 here is not directly connected to a drive source (such as an electric motor).

Instead, the supporting rotatable wheel 54 rotates on the basis of the driving motion from the first drive assembly and second drive assembly 20, 30. Accordingly, the supporting wheel assembly 50 here is a non-powered wheel assembly. Thus, the supporting rotatable wheel 54 may roll without being provided with electric-power itself. In other words, the wheel 54 is allowed to freely rotate about the third axis of rotation A₃ as a response to a contact with the ground.

To this end, the supporting wheel assembly 50 is adapted to merely provide support and stability to the powered wheelchair 100. The third linkage member 58 may be connected to the wheel 54 via e.g. a bolt or similar. The connection may further include a bearing to support the rotational motion of the supporting rotatable wheel 54.

In this exemplary embodiment, the third rotation mechanism 56 is a rotary actuator. However, other options are conceivable as long as the rotation mechanism is capable to rotate the supporting wheel assembly 50 about the pivot point P₃.

As illustrated in FIGS. 1a and 1b, the third linkage member 58 here is rotatably connected to the supporting rotatable wheel 54 at the third rotation centre R₃ (or the third axis of rotation) on one side of the wheel 54. Alternatively, the third linkage member 58 may be rotatably connected at the third axis of rotation on both sides of the wheel, as long as the wheel is allowed to rotate about its rotation centre. If the third linkage member is connected on both sides of the wheel, the third linkage member may be formed as a fork reaching to both sides of the wheel at the first axis of rotation.

Typically, the supporting wheel assembly 50 may be adapted to turn in a way that aligns with the driving direction of the wheelchair. Hence, although not strictly required, the supporting rotatable wheel may be a caster wheel arrangement. In the exemplary embodiment of FIGS. 1a and 1b, the powered wheelchair 100 here comprises a caster wheel arrangement. The caster wheel arrangement may comprise a caster wheel module and a caster wheel linkage member. The caster wheel arrangement may be operatively controlled by the control unit for controlling the position of the caster wheel module with respect to the ground and/or the chassis. For instance, the control unit can be configured to control the caster wheel module such that the caster wheel module is rotated about a caster wheel module axis of rotation in a direction towards the driving direction D of the wheelchair 100. The rotation of the caster wheel module provides improved control of the powered wheel chair when turning. In this manner, the caster wheel arrangement has a freedom of rotation such that the wheel is adapted to turn in a way that aligns with the driving (travelling) direction of the wheelchair on the ground. For electrical powered wheelchairs, this is important for efficient turning control of the wheelchair.

Analogous to the configuration of the first drive wheel assembly, the second drive wheel assembly 30 in the exemplary embodiment in FIGS. 1a and 1b includes the second driving wheel 34 having the second rotation centre R₂. The second rotation centre R₂ here corresponds to a second axis of rotation A₂ of the second driving wheel 34. The second driving wheel 34 is operatively connected to the second rotation mechanism 36 via the second linkage member 38. In other words, the second drive assembly 30 comprises the second driving wheel 34, the second rotation mechanism 36 and the second linkage member 38. Moreover, the second rotation mechanism 36 is operable to rotate the second drive wheel assembly 30 about a second pivot point P₂. Since the second driving wheel 34 is distanced from the rotation mechanism 36 by the linkage member 38, the second rotation centre R₂ is offset from the second pivot point P₂.

Moreover, in this exemplary embodiment, as is evident from FIGS. 1a and 1b, the first rotation centre R₁, the second rotation centre R₂ and the third rotation centre R₃ are offset from each other. In other words, the first linkage member 28 has a length L₁ as seen in a longitudinal direction of the first linkage member 28. Analogously, the second linkage member 38 has a length L₂ as seen in a longitudinal direction of the second linkage member 38.

Analogously, the third linkage member 58 has a length L₃ as seen in a longitudinal direction of the third linkage member 58.

By the above configuration of the second drive assembly 30, the second linkage member 38 is connected to the second driving wheel 34 in a manner that allows the second driving wheel 34 to rotate in a rolling fashion around the second rotation centre R₂. Typically, the second rotation centre R₂ corresponds to the second axis of rotation A₂. Hereby, the second driving wheel 34 is allowed to rotate around the second rotation centre R₂ upon a driving motion of a second wheel hub motor 39. The second linkage member 38 may be connected to the second driving wheel 34 via e.g. a bolt or similar. The connection may further include a bearing to support the rotational motion of the second driving wheel 34.

In this exemplary embodiment, the second rotation mechanism 36 is a rotary actuator. However, other options are conceivable as long as the rotation mechanism is capable to rotate the drive wheel assembly about the pivot point.

As illustrated in FIGS. 1a and 1b, the second linkage member 38 here is rotatably connected to the second driving wheel 34 at the second rotation centre R₂ (or the second axis of rotation) on one side of the wheel 34. Alternatively, the second linkage member 38 may be rotatably connected at the second axis of rotation on both sides of the wheel, as long as the wheel is allowed to rotate about its rotation centre. If the second linkage member is connected on both sides of the wheel, the second linkage member may be formed as a fork reaching to both sides of the wheel at the first axis of rotation.

As may be gleaned from FIGS. 1a and 1b, the first pivot point P₁, the second pivot point P₂ and the third pivot point P₃ are here offset in relation to each other. Optionally, although not strictly necessary, the first pivot point P₁, the second pivot point P₂ and the third pivot point P₃ are here offset from each other along a common transverse pivot axis A_{T}, as seen in a direction essentially transverse to the longitudinal direction X of the wheelchair (typically corresponding to the travelling/driving direction D of the wheelchair). Accordingly, by the provision that the supporting wheel assembly is arranged spaced apart from the pair of opposing drive wheel assemblies means that the first pivot point P₁, the second pivot point P₂ and the third pivot point P₃ are positioned offset in relation to each other.

Since the first pivot point P₁, the second pivot point P₂ and the third pivot point P₃ are spaced apart from each other, due to the offset as mentioned above, the pivot point arrangement allows for seat lift and tilt, variable wheelbase, as described herein, and automatic levelling of the seat frame 40.

In another exemplary embodiment (although not shown), the first pivot point P₁, the second pivot point P₂ and the third pivot point P₃ may be offset in relation to each other both in the traverse direction Y and the longitudinal direction X. However, the first pivot point P₁ and the second pivot point P₂ should typically be located along the common transverse pivot axis A_{T} so as to ensure that the pair of opposing drive assemblies 20, 30 can be operated and controlled simultaneously (i.e. synchronously) without compromising the driving function of the powered wheelchair. In this manner, the first wheel assembly and the second wheel assembly 20, 30 can be operated to pivot in synchronism at substantially the same speed.

Further, each rotation mechanism 26, 36, 56 of the powered wheelchair may be considered to form an interconnection between the seat frame and each corresponding linkage member 28, 38, 58. In other words, the rotation mechanisms 26, 36, 56 are arranged to the seat frame 40 at a first interconnection point, a second interconnection point and a third interconnection point, respectively.

In addition, each one of the rotation mechanisms 26, 36, 56 may typically have a corresponding mounting side for mounting the rotation mechanism to the seat frame. In this manner, each rotation mechanism is connected directly to the seat frame.

In other words, each rotation mechanism is operable to rotate the corresponding linkage member and the corresponding wheel (driving wheel or supporting rotatable wheel) about the corresponding pivot point.

Typically, although strictly not required, each corresponding rotation mechanism is in this exemplary embodiment arranged at each corresponding pivot point.

By rotating (or pivoting) a wheel assembly about a pivot point, it becomes possible to adjust the position of the wheel of the wheel assembly. Hence, without being bound by any theory, the pivoting of the wheel assembly about the pivot point here corresponds to a pivoting of the wheel assembly about the transverse axis (extending in the transverse direction Y) and along a path in the longitudinal direction X. The longitudinal direction X typically corresponds to the travelling direction D of the wheelchair. In other words, the pivoting motion of a wheel assembly typically occurs in the longitudinal direction X.

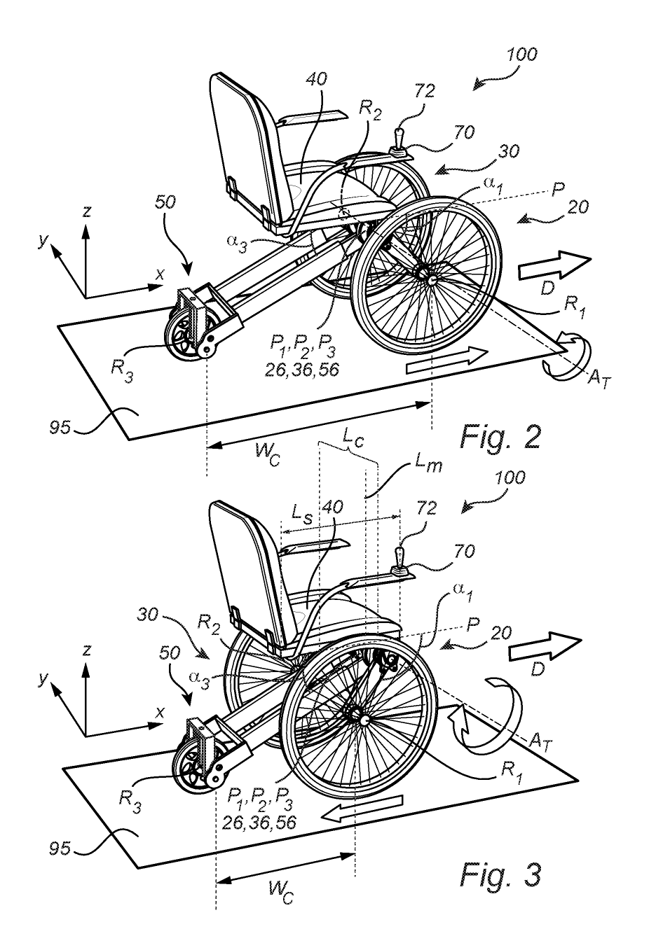

Hence, as is illustrated in FIG. 1b and more specifically in FIGS. 2 through 5, the first rotation mechanism 26 is operable to rotate the first wheel assembly 20 about a first pivot point P₁ along the longitudinal direction X of the powered wheelchair (typically considered as the driving direction D). Analogously, the second rotation mechanism 36 is operable to rotate the second wheel assembly 30 about a second pivot point P₂ along the longitudinal direction X of the powered wheelchair (typically considered as the driving direction D). Analogously, the third rotation mechanism 56 is operable to rotate the supporting wheel assembly 50 about a third pivot point P₃ along the longitudinal direction X of the powered wheelchair (typically considered as the driving direction D).

It should be readily appreciated that although each rotation mechanism allow for 360 degrees rotation about its pivot point, the rotational motion of each wheel assembly is limited to rotate from a first position to a second position due to the arrangement and configuration of the inventive concept. Hence, each rotation mechanism is operable to rotate a corresponding wheel assembly about its corresponding pivot point between a first position and a second position. For instance, the rotational movement of each wheel assembly is limited by the location of the seat frame, as is evident from FIG. 1a. In addition, each wheel assembly here is typically configured to rotate from a first position to a second position by operating and controlling the rotation mechanism in an appropriate manner. The rotation mechanism may for instance be operated and controlled by the control unit. The rotational movement of the wheel assemblies and the configuration of the rotation mechanism will be further described hereinafter in FIG. 1c through FIG. 5.

Due to above-mentioned arrangement and configuration of the wheel assemblies to the seat frame 40, each one of the wheel assemblies 20, 30, 50 is capable to be independently rotated upon operation of a corresponding rotation mechanism 26, 36, 56. More specifically, since each one of the wheel assemblies 20, 30, 50 is separately connected to a corresponding rotation mechanism 26, 36, 56, it becomes possible to independently operate each one of the wheel assemblies 20, 30, 50 in order to adjust the wheelbase of the powered wheelchair.

In addition, since the rotation mechanisms 26, 36, 56 are connected to the seat frame 40, it becomes possible to adjust the position of the seat frame 40 by adjusting the wheelbase via operation of the rotation mechanisms 26, 36, 56.

In the context of the present invention, and as illustrated in FIG. 1c, there are at least three different wheelbases w₁, w₂, w_{c} that can be adjusted by operation of the rotation mechanisms 26, 36, 56. As is evident from FIG. 1c, the first wheelbase distance w₁ is here defined by the distance between the first rotation centre R₁of the first driving wheel 24 and the third rotation centre R₃ of the supporting rotatable wheel 54, as seen in the longitudinal direction X. Analogously, the second wheelbase distance w₂ is here defined by the distance between the second rotation centre R₂ of the second driving wheel 34 and the third rotation centre R₃ of the supporting rotatable wheel 54, as seen in the longitudinal direction X.

Hence, the central wheelbase distance w_{c} is here defined by the distance between a common axis of rotation A_{C} of the first and second rotation centres R₁, R₂ and the third rotation centre R₃, as seen in the longitudinal direction X. The common axis of rotation A_{C} here refers to an axis of rotation extending in the transverse direction Y. The first driving wheel 24 and the second driving wheel 34 has a common axis of rotation when the first rotation centre R₁and the second rotation centre R₂ are aligned in the transverse direction Y upon a synchronous movement of the first and second drive assembly 20, 30 along the longitudinal direction X of the powered wheelchair 100. In this situation, the first axis of rotation A₁ and the second axis of rotation A₂ in FIG. 1b are essentially concentric to the common axis of rotation A_{C} of the first and second rotation centres R₁, R₂. In a situation when the first driving wheel 24 and the second driving wheel 34 may not have a common axis of rotation, the central wheelbase w_{c} may be measured from a mid-point 88 of an imaginary line between the first rotation centre R₁and the second rotation centre R₂, as seen in the transverse direction Y, to the third rotation centre R₃.

With reference to FIG. 1c, the first wheelbase distance w₁ is adjusted by pivoting the first driving wheel 24 relative to the supporting rotatable wheel 54. In other words, the first wheelbase distance w₁ is adjusted by pivoting the first drive wheel assembly 20, about the first pivot point P₁, and relative to the supporting the supporting wheel assembly 50. It is to be noted that any one of these two wheel assemblies may be pivoting relative to the other one of these two wheel assemblies to obtain an adjustment of the first wheelbase.

Similarly, the second wheelbase distance w₂ is adjusted by pivoting the second driving wheel 34 relative to the supporting rotatable wheel 54. In other words, the second wheelbase distance w₂ is adjusted by pivoting the second drive wheel assembly 30 relative to the supporting wheel assembly 50. It is to be noted that any one of these two wheel assemblies may be pivoting relative to the other one of these two wheel assemblies to obtain an adjustment of the second wheelbase.

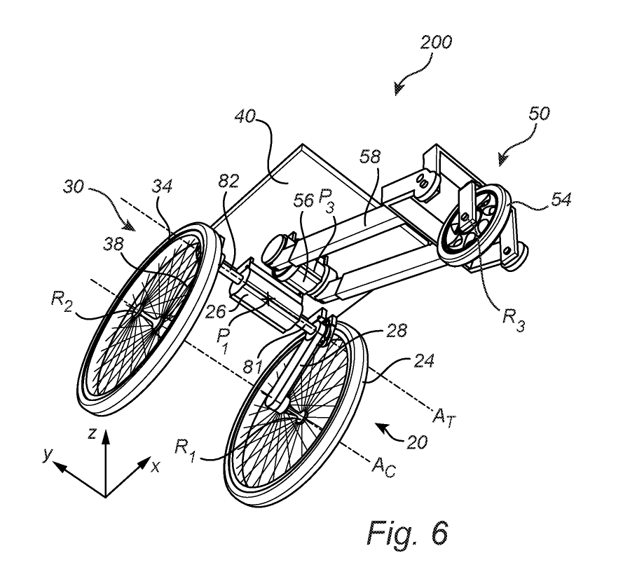

A pivoting of a wheel assembly about its pivot point, which represents at least one of the functions of the rotation mechanism, can be further defined by a pivoting angle, as illustrated by α₂ in FIG. 1c and more particularly by α₁, α₂, α₃ in FIG. 1d, and also in FIG. 6.

Accordingly, the pivoting of the first drive assembly 20 about the first pivot point P₁ is here defined by a first pivoting angle α₁, which in FIG. 1d corresponds to the angle α₁ between the seat frame 40 and the first linkage member 28. Since the first drive assembly 20 is connected to the seat frame 40, it is evident that the permissible maximum pivoting angle typically ranges between 0 and 180 degrees. Accordingly, the first drive wheel assembly 20 is pivoting in relation to the seat frame 40 by the first pivoting angle α₁. In this exemplary embodiment, the pivoting is about a transverse axis of the wheelchair and along the longitudinal direction X of the wheelchair. In other words, the pivoting motion follows a path along a vertical plane of the wheelchair, the vertical plane extending in the longitudinal direction X and in a vertical direction Z. Typically, the vertical plane is perpendicular to the ground plane 95.

The pivoting of the second drive assembly 30 about the second pivot point P₂ is defined by a second pivoting angle α₂, which in FIG. 1d corresponds to the angle α₂ between the seat frame 40 and the second linkage member 38. Since the second drive assembly 30 is connected to the seat frame 40, it is evident that the permissible maximum pivoting angle typically ranges between 0 and 180 degrees. Accordingly, the second drive wheel assembly 30 is pivoting in relation to the seat frame 40 by the second pivoting angle α₂. Similar to the pivoting motion of the first drive assembly, the pivoting here is about a transverse axis of the wheelchair and along the longitudinal direction X of the wheelchair.

The pivoting of the supporting wheel assembly 50 about the third pivot point P₃ is defined by a third pivoting angle α₃, which in FIG. 1d corresponds to the angle α₃ between the seat frame 40 and the third linkage member 58. Since the supporting wheel assembly 50 here is connected to the seat frame 40, it is evident that the permissible maximum pivoting angle typically ranges between 0 and 180 degrees. Accordingly, the supporting wheel assembly is pivoting in relation to the seat frame 40 by the third pivoting angle α₃. Similar to the pivoting motion of the first drive assembly, the pivoting here is about a transverse axis of the wheelchair and along the longitudinal direction X of the wheelchair.

Accordingly, a position of a wheel assembly can be adjusted by changing the value of a corresponding pivoting angle.

In addition, a change of the wheelbase can be obtained e.g. by changing the value of the pivoting angle α₃, or by changing the values of the pivoting angle α₁, α₂ and α₃.

Moreover, in this exemplary embodiment, a tilting of the seat frame is obtained by changing the values of the pivoting angle α₁, α₂ and α₃, preferably in synchronism.

As an example, the pivoting angles α₁, α₂, α₃ may be between 10-150 degrees. Still preferably, the pivoting angles α₁, α₂, α₃ may be between 30-135 degrees. Still preferably, the pivoting angles α₁, α₂, α₃ may be between 45-110 degrees.

It should be noted that the pivoting angles α₁, α₂, α₃ are typically defined between the seat frame 40 and the relevant wheel assembly, but may be measured between an imaginary plane P (typically extending in the XY-plane) being parallel to the seat frame 40 and the relevant wheel assembly, as shown in FIG. 1e.

Advantages with this exemplary embodiment, as described in relation to the FIGS. 1a through 5b, are that the rotation of the first drive wheel assembly 20 can be operated and controlled independently of the second drive wheel assembly 30 and the supporting wheel assembly 50, the rotation of the second drive wheel assembly 30 can be operated and controlled independently of the first drive wheel assembly 20 and the supporting wheel assembly 50 and the rotation of the supporting wheel assembly 50 can be operated and controlled independently of the first drive wheel assembly 20 and the second drive wheel assembly 30.

FIG. 1e is a side-view illustrating further details of the exemplary embodiment of the powered wheelchair in e.g. FIG. 1a. As is evident from FIG. 1e, the adjustable seat height 74 of the seat frame 40 can be defined between the ground plane 95 and a ground-facing surface 78 of the seat frame. In addition, FIG. 1e shows the vertical distance 76 between the pivot points, e.g. pivot point P₁ and the ground-facing surface 78. FIG. 1e further illustrates the relationship between the wheelbase(s), here illustrated in the form of the first wheelbase w₁ and the lengths L₁, L₂ and L₃ of the linkage members 28, 38 and 58. As may be gleaned from FIG. 1e the length L₁ (L₂) of a linkage member of any one of the drive wheel assemblies 20, 30 may not necessarily correspond to a driving wheel diameter D₁ (D₂). Also, the supporting rotatable wheel 54 may have supporting rotatable wheel diameter D₃. FIG. 1e further illustrate the pivoting angles α₁, α₂, α₃, which here extends between the seat plane and corresponding linkage members 28, 38 or 58. Moreover, in this exemplary embodiment, the rotation mechanisms 26, 36, 56 are connected to the seat frame 40 at the front of the seat frame 40, as seen in the longitudinal direction X. More particular, the rotation mechanisms 26, 36, 56 are connected to the seat frame 40 by a distance 75 from a centre area (or point) of the seat frame 40. In other words, each one of the pivot points P₁, P₂, P₃ is arranged at a distance 75 from the centre area of the seat frame 40. However, it should be readily appreciated that the distance between a pivot point and the centre area of the seat frame may be different for each pivot point as long as the functions of the inventive concept, as described herein, are not compromised. As an example, the pivot point P₃ may be positioned spaced apart from the first pivot point P₁ and the second pivot point P₂ as seen the in longitudinal direction X.

FIG. 1f illustrates a detailed view of another exemplary embodiment of the present inventive concept as generally described in relation to FIG. 1a, in which the rotation mechanisms are connected to the seat frame in an alternative configuration, as described hereinafter.

In this exemplary embodiment, the third rotation mechanism 56 is connected to the seat frame 40 as mentioned above, while the first rotation mechanism 26 and the second rotation mechanism 36 are mounted to the third linkage member 58 and connected to the seat frame via the third linkage member. In other words, the third rotation mechanism 56 is directly connected to the seat frame 40, while the first rotation mechanism 26 and the second rotation mechanism 36 are indirectly connected to the seat frame 40 via the third linkage member 58. That is, the rotation mechanisms are connected to the seat frame in an alternative manner compared to the configuration illustrated in FIG. 1d. Although not shown in the figure, the third rotation mechanism 56 here has a mounting side for mounting the rotation mechanism to the seat frame 40. Similarly, the first rotation mechanism 26 has a mounting side for attachment to the third linkage member 58. Analogously, the second rotation mechanism 36 has a corresponding mounting side for attachment to the third linkage member 58.

With respect to the pivoting adjustment of the rotation mechanism and the wheel assemblies, the pivoting of the supporting wheel assembly 50 about the third pivot point P₃ is defined by the third pivoting angle α₃, as mentioned above. That is, the angle α₃ refers to the angle defined between the seat frame 40 and the third linkage member 58, as shown in FIG. 1f. However, as a consequence of the alternative mounting arrangement of the first rotation mechanism 26 and the second rotation mechanism 36 to the third linkage member 58, the pivoting of the first drive assembly 20 about the first pivot point P₁ is in this exemplary embodiment defined by a fifth pivoting angle α₅, which in FIG. 1f corresponds to the angle α₅ between the first linkage member 28 and the third linkage member 58. Analogously, the pivoting of the second drive assembly 30 about the second pivot point P₂ is defined by a fourth pivoting angle α₄ which in FIG. 1f corresponds to the angle α₄ between the second linkage member 38 and the third linkage member 58.

Besides this difference, the exemplary embodiment in FIG. 1f may typically include the other functions and features described above with reference to FIG. 1a.

Accordingly, the powered wheelchair is here operated by pivoting the rotation mechanisms according to the pivoting angles α₃, α₄ and α₅. That is, a position of the first wheel assembly can be adjusted by changing the value of the pivoting angle α₅, a position of the second wheel assembly can be adjusted by changing the value of the pivoting angle α₄ and a position of the third wheel assembly can be adjusted by changing the value of the pivoting angle α₃.

Thus, a change of the wheelbase can be obtained by changing the value of the pivoting angles α₃, α₄ and α₅.

Moreover, in this exemplary embodiment, a tilting of the seat frame is obtained merely by changing the value of the pivoting angle α₃.

As mentioned above, the wheelbase(s) can be adjusted via any one of the rotation mechanism(s) to obtain as set of predetermined mode of the powered wheelchair. The various modes of the powered wheelchair 100 will now be described with reference to FIGS. 2-4.

FIG. 2 is a perspective view illustrating an exemplary embodiment of the powered wheelchair in an outdoor mode, in which the powered wheelchair has a long wheelbase. This configuration has the advantage of getting front drive wheels in front of the leg or foot rest assembly that are normally used, in order to for example climb up a curb without collision with foot rest.

The powered wheelchair is here transformed to the outdoor mode by independently operating the first rotation mechanism 26, the second rotation mechanism 36 and the third rotation mechanism 56 to adjust the central wheelbase w_{c}.

In the context of the present invention, it is to be noted that since the wheels 24, 34, 54 of the powered wheelchair 100 are typically in contact with the ground surface 95 when any one of the rotation mechanisms are operated, at least during normal use of the wheelchair, an adjustment of the position of any one of the wheel assemblies may result in that the position (e.g. height) of the seat frame 40 of the wheelchair is changed since the lengths of the linkage members 28, 38, 58 (essentially defining the distance from the wheel to the seat frame) are constant.

The wheelbase can be increased by several different operations of the rotation mechanisms in order to transform the wheelchair into the outdoor mode. As an example, the first drive wheel assembly 20 and the second drive wheel assembly 30 may be rotated about their corresponding pivot points P₁ and P₂ in a direction away from the supporting wheel assembly 50 (typically corresponding to the travelling direction D), while the supporting wheel assembly 50 remains its position or rotates in a direction away from the first and second drive wheel assemblies 20, 30 (typically corresponding to a direction opposite the travelling direction D). In order to transform the powered wheelchair in rapid and smooth manner, the first drive wheel assembly 20 and the second drive wheel assembly 30 can simultaneously pivot about their corresponding pivot points P₁ and P₂ in an aligned manner, i.e. the wheel assemblies 20, 30 rotate at the same time and essentially at the same pivoting speed.

A long wheelbase (outdoor mode) may also be obtained by pivoting the supporting wheel assembly 50 in a direction away from the first driving wheel assembly 20 and the second driving wheel assembly 30, typically corresponding to a direction opposite the travelling direction D, while the first driving wheel assembly 20 and the second driving wheel assembly 30 remain their position or rotate in a direction away from the supporting wheel assembly 50 (typically corresponding to the travelling direction D). This type of operation may for instance be utilized when the powered wheelchair is transformed from a stand-up mode into the outdoor mode.

It should be readily appreciated that the ultimate pivoting of the rotation mechanism(s) 26, 36, 56 to transform the wheelchair into the outdoor mode may depend on the initial wheelbase distance.

The drive system is normally disabled during transformation between the modes, but in order to preserve the overall position in the driving direction, the drive wheels may compensate for the effective change of position between the drive wheels and seat frame to effectuate a transformation without movement of the seat relative to ground.

A powered wheelchair having a long wheelbase (outdoor mode) may typically refer to a configuration of the powered wheelchair in which the first rotation centre R1 and the second rotation centre R2 are positioned in front of the first pivot point P1 and the second point P2, as seen in the longitudinal direction X, as illustrated in FIG. 2.

The outdoor mode may also be defined by the level of the pivoting angles α₁, α₂, α₃. Although the pivoting angles of an outdoor mode may differ for various wheelchair designs, one example of a suitable outdoor mode can be obtained by pivoting the first drive wheel assembly 20 to a first pivot angle α₁ of about 45 degrees, the second drive wheel assembly 30 to a second pivot angle α₂ of about 45 degrees and the supporting wheel assembly 50 to a third pivot angle α₃ of about 30 degrees.

By this adjustment of the wheelbase to a long wheelbase, the pair of opposing drive wheel assemblies 20, 30 is typically positioned in the front of the wheelchair (as seen in the longitudinal direction X), as illustrated in FIG. 2. Accordingly, the wheelbase may be increased such that the powered wheelchair 100 is in an outdoor mode, where the pair of the opposing drive wheel assemblies 20, 30 is positioned in front of the seat frame 40 of the powered wheelchair, as seen in the longitudinal direction X of the powered wheelchair, typically corresponding to the travelling direction D. In the exemplary embodiment when the pair of opposing driving wheels are provided as front driving wheels 24, 34 having a large diameter (typically also larger than the supporting rotatable wheel), the powered wheelchair is provided with an improved obstacle climbing ability. Especially, in a situation when each one of the first front driving wheel 24 and the second front driving wheel 34 are separately controlled via the rotation mechanisms 26, 36, respectively, this type of arrangement allows for inclinometer sensor feedback (e.g. by utilizing a sensor), while maintaining the seat frame 40 in a constant horizontal plane regardless of terrain. This type of arrangement is particularly useful when the powered wheelchair drives into a kerbstone at a slant angle, which may be traversed by a wheel-by-wheel climbing of the first and second drive wheel assemblies 20, 30 (similar to the situation illustrated in FIG. 5).

FIG. 3 is a perspective view illustrating an exemplary embodiment of the powered wheelchair in an indoor mode, in which the powered wheelchair has a short wheelbase. A powered wheelchair having a short wheelbase is compact and will therefore fit into small indoor spaces. Also manoeuvring of the wheelchair is enhanced since the two wheels (i.e. the first driving wheel 24 and the second driving wheel 34) are basically centred in the vehicle, which allows for on the spot rotation.

The powered wheelchair is here transformed to the indoor mode by independently operating the first rotation mechanism 26, the second rotation mechanism 36 and the third rotation mechanism 56 to adjust the central wheelbase w_{c}. In the context of the present invention, it is to be noted that since the wheels of the powered wheelchair are typically in contact with the ground surface 95 when any one of the rotation mechanisms are operated, at least during normal use of the wheelchair, an adjustment of the position of any one of the wheel assemblies may result in that the position (e.g. height) of the seat frame 40 of the wheelchair is changed since the lengths of the linkage members 28, 38, 58 (essentially defining the distance from the wheel to the seat frame) are constant, i.e. the seat height will have to change momentarily during transformation between for example outdoor to indoor mode.

The wheelbase can be shortened by several different operations of the rotation mechanisms in order to transform the wheelchair into the indoor mode. As an example, the first drive wheel assembly 20 and the second drive wheel assembly 30 may be rotated about their corresponding pivot points P₁, P₂ in a direction towards the supporting rotatable wheel 50 (typically corresponding to a direction opposite the travelling direction D), while the supporting wheel assembly 50 remains its position or rotates in a direction towards the first and second drive wheel assemblies 20, 30 (typically corresponding to the travelling direction D). In order to transform the powered wheelchair in rapid and smooth manner, the first drive wheel assembly 20 and the second drive wheel assembly 30 can simultaneously pivot about their corresponding pivot points P₁ and P₂ in an aligned manner, i.e. the wheel assemblies 20, 30 rotate at the same time and at the same pivoting speed.

It should be readily appreciated that the ultimate pivoting of the rotation mechanism(s) 26, 36, 56 to transform the wheelchair into the indoor mode may depend on the initial wheelbase distance.

A powered wheelchair having a short wheelbase (indoor mode) may typically refer to a configuration of the powered wheelchair in which the first rotation centre R1 and the second rotation centre R2 are positioned behind the first pivot point P1 and the second point P2, as seen in the longitudinal direction X, as illustrated in FIG. 3.

The indoor mode may also be defined by the level of the pivoting angles α₁, α₂ and α₃. Although the pivoting angles of an indoor mode may differ for various wheelchair designs, one example of a suitable indoor mode can be obtained by pivoting the first drive wheel assembly 20 to a first pivot angle α₁ of about 135 degrees, the second drive wheel assembly 30 to a second pivot angle α₂ of about 135 degrees and the supporting wheel assembly 50 to a third pivot angle α₃ of about 30 degrees.

By this adjustment of the wheelbase to a short wheelbase, the pair of opposing drive wheel assemblies 20, 30 is typically positioned in a mid section of the wheelchair (as seen in the longitudinal direction X), as illustrated in FIG. 3. The mid section of the powered wheelchair 100 may be defined by a centre area L_{C} of the extension of the seat frame 40 in the longitudinal direction X. That is, the centre area L_{c} is positioned in the centre of the longitudinal length L_{S} of the seat frame 40, as illustrated in FIG. 3. Hence, the meaning of the provision that the pair of opposing drive wheel assemblies 20, 30 is typically positioned in a mid section of the wheelchair refers to the situation when the rotation centres R₁and R₂ are positioned in centre area L_{C}, which in FIG. 3 is illustrated by a dashed line Lₘ (projecting from the rotation centres R₁and R₂) the being within the centre area L_{C}. Accordingly, the wheelbase may be shortened such that the powered wheelchair is in an indoor mode, where the pair of the opposing drive wheel assemblies 20, 30 is positioned in a mid section of the powered wheelchair, as seen in the longitudinal direction X of the powered wheelchair, typically corresponding to the travelling direction D.

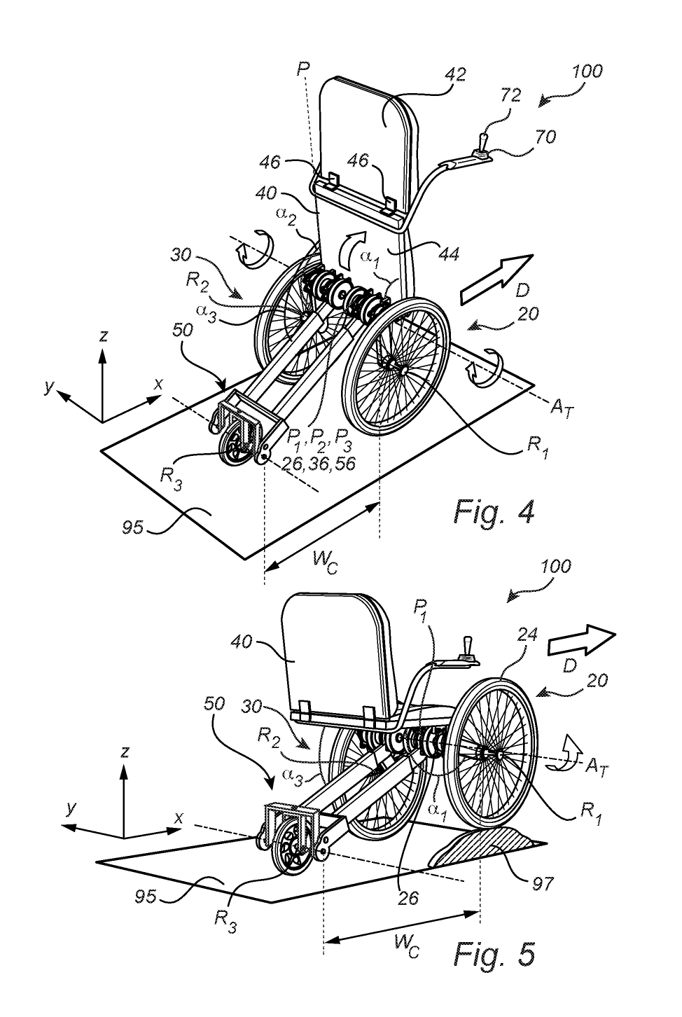

When positioned in the indoor mode, the complete vehicle will be at risk of tipping forward depending on centre of gravity and braking etc. Thus it may be needed to have some kind of front support wheel arrangement to be deployed in the indoor mode. However, the front support arrangement is merely optional and several different approaches are conceivable. FIG. 4 illustrates an exemplary embodiment of the powered wheelchair 100 in a stand-up mode, corresponding to an essentially vertical orientation of the powered wheelchair, as seen in a vertical direction Z. In this exemplary embodiment, the seat frame 40 may include a first support section 42 pivotably connected to a second support section 44, wherein the wheelbase w_{c} is adjusted such that the seat frame 40 is positioned in a substantially vertical orientation (up-right position). In this manner, the powered wheelchair 100 transforms into the stand-up mode. In other words, the stand-up mode here refers to a mode when the seat frame 40 is in an essentially vertical orientation, as seen relative to the ground plane 95. In this exemplary embodiment, the first support section is a back support section 42, while the second support section is a seat cushion support section 44. The seat cushion support section 44 is here connected to the back support section 42 by a joint 46. The joint is configured to angle the back support section 42 relative to the seat cushion support section 44 so that the seat frame 40 can adopt different positions based on the desired support for the passenger. The joint 46 may typically include a rotary actuator to effectuate the movement of the back support section 42 relative to the seat cushion support section 44.

Similar to the modes relating to the outdoor mode and the indoor mode, the powered wheelchair can transform into the substantially vertical orientation (up-right position) of the seat frame by independently operating the first rotation mechanism 26, the second rotation mechanism 36 and the third rotation mechanism 56 to adjust the central wheelbase w_{c}. Simultaneously, or slightly after the adjustment of the wheelbase, the joint 46 should be adjusted accordingly in order to ensure that the back support section 42 is sufficiently angled relative to the seat cushion support section 44. The joint may be operated by the control unit 70 similar to the situation with the rotation mechanisms. Hence, the control unit here is configured to operate the rotation mechanisms 26, 36, 56 and the joint 46.

The stand-up mode can be obtained by adjusting the wheelbase in several different ways. Since several alternatives of pivoting the rotation mechanisms have been described in relation to FIGS. 2-3, it should be readily appreciated that the ultimate pivoting of the rotation mechanisms to transform the wheelchair into the stand-up mode may depend on the initial wheelbase distance.

However, in the context of the present invention, the stand-up mode may also be defined by the level of the pivoting angles α₁, α₂, α₃. Although the pivoting angles of a stand-up mode may differ for various wheelchair designs, one example of a suitable stand-up mode can be obtained by pivoting the first drive wheel assembly 20 to a first pivot angle α₁ of about 0 degrees, the second drive wheel assembly 30 to a second pivot angle α₂ of about 0 degrees and the supporting wheel assembly 50 to a third pivot angle α₃ of about 120 degrees. The pivot angles are here defined in view of the seat plane P, which intersects the rotation mechanisms about corresponding pivot points.

By this adjustment of the wheelbase, the user-facing surface of the seat frame 40, as defined by the user-facing surfaces of the back support section 42 and the seat cushion support section 44, is typically positioned in a substantially vertical orientation, as illustrated in FIG. 4. Accordingly, the wheelbase is adjusted by operation of any one of the wheel assemblies 20, 30, 50 such that the powered wheelchair 100 transforms into its stand-up mode, where the seat frame 40 is typically positioned in a substantially vertical orientation (and flat), typically extending in the vertical direction Z corresponding to a direction perpendicular to the travelling direction D. In other words, by adjusting the wheelbase, e.g. by pivoting the pair of opposing wheel assemblies towards the support wheel assembly, the seat cushion support section 44 is pivoting about the axis A_{T} so that a user-facing surface of the seat support section is directed towards the forward direction (here corresponding to the travelling direction D). As is readily appreciated from the configuration of the inventive concept, this pivoting motion of the seat frame is provided by having the rotation mechanism(s) connected to the seat frame 40 in a fixated manner.

If the powered wheelchair is fitted with a leg rest length adjust actuator and/or a leg rest angle actuator, these type of actuators may also be included in the transformation to and from stand-up mode. The leg rest angle is typically adjusted so that it aligns with the seat (almost vertical) and the leg rest length adjust actuator may be adjusted during this transformation to increase comfort for the user.

As shown by the various situations (or modes) illustrated in FIGS. 2 through 4, the powered wheelchair is capable of providing an improved control function, while enabling a transformation between various operational modes, such as indoor mode, outdoor mode and a stand-up mode. Hence, the present inventive concept hereby alleviates the drawbacks of many conventional powered wheelchairs. In fact, most of the existing solutions of stand-up functionality make use of additional servo or actuators and mechanical linkage systems to achieve the stand-up motion.

In addition, since the pair of the opposing driving wheel assemblies 20, 30 and the supporting wheel assembly 50 are connected to the seat frame 40, the user of the powered wheelchair may select to adjust the position of the seat frame by adjusting the position of any one of the wheel assemblies, e.g. by pivoting a wheel assembly about its corresponding pivot point.

FIG. 5 illustrates a situation when an obstacle is to be traversed by a powered wheelchair 100 according to an exemplary embodiment of the present inventive concept.

In this situation, the obstacle is to be traversed with one of the front drive wheel assemblies, e.g. the first drive wheel assembly 20. Due to the configuration and arrangement of the wheel assemblies 20, 30, 50 being independently operated about the corresponding rotation mechanisms 26, 36, 56, the powered wheelchair is capable of traversing an obstacle 97, such as a stone, pavement or kerb stone without compromising user comfort. As an example, an obstacle 97 in front of the first driving wheel 24 can be traversed by pivoting the first wheel assembly 20 about the first pivot point P₁, as shown in FIG. 5. Since the first wheel assembly 20 is pivoting about the first pivot point P₁ independently of the other wheel assemblies, the powered wheelchair 100 is capable of being operated so that the seat cushion 44 of the seat frame 40 of the wheelchair 100 can maintain a user-friendly position when the obstacle 97 is being traversed. In this context of the present invention, a user-friendly position often corresponds to an essentially horizontal level of the seat cushion 44 of the seat frame 40. Moreover, the powered wheelchair 100 hereby allows for improved curb and obstacle climbing by ensuring that the wheel assemblies 20, 30, 50 can be independently controlled via operation of corresponding rotation mechanisms 26, 36, 56. The rotation mechanism(s) can be operated to lateral tilt at least a part of the seat frame about a tilt axis of the seat frame. In addition, or alternatively, the rotation mechanism(s) can be operated to tilt at least a part of the seat frame forward and/or rearward, as seen in a travelling direction D of the powered wheelchair 100. The lateral tilt may be effected by pivoting at least one of the first drive wheel assembly 20 and the second drive wheel assembly 30. Typically, the first drive wheel assembly 20, the second drive wheel assembly 30 and the supporting wheel assembly 50 are pivoting about their corresponding pivot points in synchronism to tilt the seat frame in a smooth manner. Further, a virtual pivot point can be arbitrarily set anywhere on or in the vicinity of the seat frame 40 so that the three main pivot axis are controlled in such a way that the tilt command given by the joystick (user-interface) rotate the seat frame around this virtual pivot point. Typically it is preferred to have this virtual pivot point about 10 cm above the seat cushion 44, as seen in the vertical direction Z. Hereby, the user gets the feeling that the tilt pivot point are approximately the same as the hip joint of the user.

In addition, or alternatively, the first rotation mechanism 26, the second rotation mechanism 36 and the third rotation mechanism 56 may be independently operable to lift at least a part of the seat frame 40, as seen in a direction perpendicular (vertical direction Z) to the driving direction.

As mentioned above, the first drive wheel assembly 20 and the second drive wheel assembly 30 are simultaneously operated, e.g. by the control unit. In this manner, the pair of opposing drive wheel assemblies can be adjusted synchronously in order to directly adjust the central wheelbase of the powered wheelchair. This means that the first and the second drive assemblies are adjusted in synchronism at substantially the same speed.

FIG. 6 illustrates schematically at least another exemplary embodiment of the present inventive concept. As described above in relation to the first example embodiment, the powered wheelchair 200 is suitable for transporting a person. The powered wheelchair 200 also includes the seat frame 40 for supporting the person, a pair of opposing drive wheel assemblies 20, 30 configured to drive the powered wheelchair 200 and connected to the seat frame 40. In addition, the wheelchair 200 includes a supporting wheel assembly 50 arranged spaced apart from the pair of drive wheel assemblies 20, 30 and connected to the seat frame 40. The pair of opposing drive wheel assemblies 20, 30 here comprises the first drive wheel assembly 20 and the second drive wheel assembly 30.

The first drive wheel assembly 20 includes a first driving wheel 24 having a first rotation centre R₁and operatively connected to a first rotation mechanism 26 via the first linkage member 28. The first rotation mechanism 26 is operable to rotate the first drive wheel assembly 20 about the first pivot point P₁, wherein the first rotation centre R₁is offset from the first pivot point P₁.

One difference between the embodiment depicted in FIG. 1a and the embodiment depicted in FIG. 6 is that the second drive wheel assembly 30 is not connected to a second rotation mechanism. Instead, at least in this exemplary embodiment, the second drive wheel assembly 30 includes a second driving wheel 34 having a second rotation centre R₂ and operatively connected to the first rotation mechanism 26 via a second linkage member 38. Moreover, the first rotation mechanism 26 is, in this exemplary embodiment, operable to rotate the second drive wheel assembly 30 about the first pivot point P₁, wherein said second rotation centre R₂ is offset from said first pivot point P₁.

Similar to the exemplary embodiment depicted in FIG. 1a, the embodiment depicted in FIG. 6 has a supporting wheel assembly 50, which includes the supporting rotatable wheel 54 having a third rotation centre R₃ and operatively connected to the third rotation mechanism 56 via the third linkage member 58. The third rotation mechanism 56 is operable to rotate the supporting wheel assembly 50 about the third pivot point P₃, wherein said third rotation centre R₃ is offset from said third pivot point P₃.

By this exemplary embodiment, it becomes possible to provide a powered wheelchair 200, in which the central wheelbase is adjusted based on operating any one of the first rotation mechanism 26 and third rotation mechanism 56 independently, whilst the first rotation mechanism 26 is configured to rotate both the first drive wheel assembly 20 and the second drive wheel assembly 30. Hence, in this arrangement, the first drive wheel assembly 20 and the second drive wheel assembly 30 are configured to rotate about the same pivot point P₁.

As may be gleaned from FIG. 6, the rotation mechanism 26 is arranged centrally in-between the first linkage member 28 and the second linkage member 38, as seen in the transverse direction Y. In this configuration, another bridging member portion 81 may be arranged to connect the first linkage member 28 with the rotation mechanism 26. Analogously, another bridging member portion 82 may be arranged to connect the second linkage member 38 with the rotation mechanism 26. However, other configurations are conceivable as long as the driving wheels are operatively connected to the rotation mechanism 26. For instance, each one of the linkage members 28, 38 may be slightly inwardly inclined to directly connect with the rotation mechanism 26.

In other words, when the first rotation mechanism 26 is configured to rotate both the first drive wheel assembly 20 and the second drive wheel assembly 30 so that the first drive wheel assembly and the second drive wheel assembly rotate about the same pivot point, i.e. the first pivot point P₁, a central wheelbase distance, as defined by the distance between a common axis of rotation A_{C} of the first driving wheel and the second driving wheel, as defined by the first and second rotation centres, and the third rotation centre of the supporting rotatable wheel, can be adjusted by pivoting the first drive wheel assembly 20 and the second drive wheel assembly 30 about the first common axis of rotation A_{T} and/or the supporting wheel assembly 50 about the third pivot point P₃.

In this exemplary embodiment, other features of the powered wheelchair 200 are the same as described for the exemplary embodiment of the powered wheelchair 100 in FIG. 1a above. Hence, the wheelchair 200 may optionally include the details relating to the control unit, driving function etc.

In another exemplary embodiment (not shown), the second driving wheel may be operatively connected to the first rotation mechanism via the second linkage member so that the first rotation mechanism is operable to rotate the second drive wheel assembly about a second pivot point. In this exemplary embodiment, the second pivot point is offset from the first pivot point whilst being located on a common axis of rotation. An offset between the first pivot point and the second pivot point may be realised by having an intermediate linkage member extending from the rotation mechanism along the axis of rotation, which is connected to the first and second linkage members.

In addition, in each of the above described exemplary embodiments in FIGS. 1a-6 and in other embodiments, the powered wheelchair 100, 200 may further comprise an accelerometer (not shown) to operate any one of the first rotation mechanism 20, the second rotation mechanism 30 and the third rotation mechanism 50. In addition, or alternatively, the powered wheelchair 100, 200 may further comprise a gyro (not shown) to operate any one of the first rotation mechanism 20, the second rotation mechanism 30 and the third rotation mechanism 50. In this manner, the powered wheelchair can be controlled (or operated) such that a levelled position of the seat frame is maintained regardless of terrain. By utilizing an accelerometer/gyro, the control unit can be configured to measure, record and compare the wheelchair's actual movement. In this manner, it becomes possible to provide essential information to optimize drive and “levelling” regulator characteristics to suit different situations as they occur. As an example, if the terrain is essentially flat (like a floor), the powered wheelchair may be operated via the control unit to turn off the levelling regulators in order to save battery capacity. Another example of the use of a control unit combined with an accelerometer and/or gyro is when a high obstacle is detected (like a kerbstone). In this situation, it would be optimal to immediately reduce the maximum speed of the wheelchair, while estimating whether the obstacle is too high to be traversed by the wheelchair. By utilizing the above arrangement, the powered wheelchair is capable of automatically avoiding attempts to climb dangerous terrain. This function of the powered wheelchair may also be utilized on slanted terrain to avoid tipping sideways.

As mentioned above, the powered wheelchair may therefore also include a control unit 70, as illustrated in e.g. FIG. 1a. The control unit can be configured in several different ways according to the requirements and functions of the powered wheelchair. Thereby, the powered wheelchair 100 may provide advanced control functions, such as height- and tilt control of the seat frame and/or levelled seat position regardless of terrain. Accordingly, in each of the above described exemplary embodiments in FIGS. 1a-6 and in other embodiments, the powered wheelchair may further comprise a control unit 70 for operating any one of the first rotation mechanism 26, the second rotation mechanism 36 and the third rotation mechanism 56.

One example of a suitable control unit or control system can be provided by a central processor which is configured to evaluate signals from the inclinometer and the joystick. The central processor may further be connected via a bus system to local nodes that control each servo motor that is included in the powered wheelchair. For example, the powered wheelchair may include a servo motor for the drive motors, three motors for the above-mentioned rotation mechanisms, a back rest angle motor, a leg rest angle motor and a leg rest length adjustment motor.

The control unit may include an algorithm, additional software and/or hardware to record the terrain topology as the powered wheelchair travels.

In addition, or alternatively, the control unit 70 may be configured to adjust any one of the wheelbases w₁, w₂, w_{c} of the powered wheelchair 100, 200 based on an operation of any one of the first rotation mechanism 26, second rotation mechanism 36 and third rotation mechanism 56.

In addition, or alternatively, the control unit may be configured to adjust a tilt angle of a part of the seat frame 40 by operating any one of the first rotation mechanism, second rotation mechanism and third rotation mechanism.

In addition, or alternatively, the control unit 70 may be configured to adjust the height of a part of the seat frame by operating any one of the first rotation mechanism, second rotation mechanism and third rotation mechanism.

In addition, or alternatively, the control unit 70 may be configured to maintain a tilt angle of a part of the seat frame 40 at a predetermined set point.

In addition, or alternatively, the control unit 70 may be configured to maintain the height of a part of the seat frame 40 at a predetermined set point. The height of the seat frame can for example be calculated as the shortest distance between a centre point of the seat frame (preferably coinciding with the virtual tilt axis) and the ground surface 95. In this way, the height is calculated without use of any inclinometer signals.

In addition, or alternatively, the control unit 70 may be configured to gather data indicative of the prevailing terrain topology upon movement of the powered wheelchair. In addition, or alternatively, the control unit 70 may be configured to evaluate said data indicative of the prevailing terrain topology to adjust the characteristics of the control unit 70 relating to control of drive and seat adjustments. For example, the data indicative of prevailing terrain topology can be used to set a limit of maximum speed in uphill driving. In addition, or alternatively, the data indicative of prevailing terrain topology can be used to turn off the adjustment of the seat frame 40 in situations when the terrain topology is sufficiently flat for a smooth driving of the powered wheelchair in order to save battery. In addition, or alternatively, the control unit 70 may be configured to operate any one of the first rotation mechanism, the second rotation mechanism and the third rotation mechanism based on said evaluated data to adjust the wheelbase(s) of the powered wheelchair 100, 200.

In all exemplary embodiments of the present inventive concept, the powered wheelchair 100, 200 may be powered by an electric motor.

In all exemplary embodiments of the present inventive concept, a rotation mechanism may be provided in the form of a rotary actuator. One example of a rotary actuator is a servo. Rotary actuators are commercially available and can be provided in many sizes and shapes. One example of a rotary actuator suitable for the powered wheelchair is a brushless servo motor fitted with a worm gear.

Thanks to present inventive concept, it becomes possible to provide a powered wheelchair that is capable to transform shape and wheelbase upon a rotation of any one of the rotation mechanisms. More specifically, due to the arrangement that each one of the wheel assemblies are separately connected to corresponding rotation mechanisms, it becomes possible to independently operate each one of the wheel assemblies in order to adjust the wheelbase of the powered wheelchair.

It is to be understood that the present invention is not limited to the embodiments described above and illustrated in the drawings; rather, the skilled person will recognize that many changes and modifications may be made within the scope of the appended claims. For example, although the invention has been described in relation to powered wheelchair having one rear supporting rotatable wheel, it should be readily appreciated that rear support wheel assembly may include another rear supporting rotatable wheel.

1. A powered wheelchair for transporting a person comprising a seat frame for supporting the person, a pair of opposing drive wheel assemblies configured to drive said powered wheelchair and connected to the seat frame, and a supporting wheel assembly arranged spaced apart from the pair of opposing drive wheel assemblies and connected to the seat frame, the pair of opposing drive wheel assemblies comprising a first drive wheel assembly and a second drive wheel assembly, wherein
said first drive wheel assembly includes a first driving wheel having a first rotation centre and operatively connected to a first rotation mechanism via a first linkage member, said first rotation mechanism is operable to rotate said first drive wheel assembly about a first pivot point. wherein said first rotation centre is offset from said first pivot point, and
said supporting wheel assembly includes a supporting rotatable wheel having a third rotation centre and operatively connected to a third rotation mechanism via a third linkage member, said third rotation mechanism is operable to rotate said supporting wheel assembly about a third pivot point, wherein said third rotation centre is offset from said third pivot point.

2. The powered wheelchair according to claim 1, wherein the first rotation mechanism and the third rotation mechanism are independently operable to adjust a position of the seat frame.

3. The powered wheelchair according to claim 1, wherein said second drive wheel assembly includes a second driving wheel having a second rotation centre and operatively connected to said first rotation mechanism via a second linkage member, said first rotation mechanism is operable to rotate the second drive wheel assembly about the first pivot point, wherein said second rotation centre is offset from said first pivot point.

4. The powered wheelchair according to claim 1, wherein the second drive wheel assembly includes a second driving wheel having a second rotation centre and operatively connected to a second rotation mechanism via a second linkage member, said second rotation mechanism is operable to rotate the second drive wheel assembly about a second pivot point, wherein said second rotation centre is offset from said second pivot point.

5. The powered wheelchair according to claim 4, wherein the first rotation mechanism, the second rotation mechanism and the third rotation mechanism are independently operable to adjust a position of the seat frame.

6. The powered wheelchair claim 1, wherein any one of the first rotation mechanism, the second rotation mechanism and the third rotation mechanism is independently operable to adjust the wheelbase of the powered wheelchair.

7. The powered wheelchair according to claim 1, wherein the powered wheelchair is transformable into a set of modes including an indoor mode, an outdoor mode and a stand-up mode by an adjustment of the wheelbase of the powered wheelchair by means of any one of the first rotation mechanism, the second rotation mechanism and the third rotation mechanism.

8. The powered wheelchair according to claim 1, wherein the first drive wheel assembly and the second drive wheel assembly are operable in synchronism.

9. The powered wheelchair according to claim 1, wherein the powered wheelchair further comprises a control unit for operating any one of the first rotation mechanism, the second rotation mechanism and the third rotation mechanism.

10. The powered wheelchair according to claim 1, wherein the powered wheelchair further comprises an inclinometer configured to operate any one of the first rotation mechanism, the second rotation mechanism and the third rotation mechanism based on a regulatory algorithm to maintain seat tilt angles and riding height, respectively, at user definable set-points.

11. The powered wheelchair according to claim 9, wherein the control unit is configured to gather data indicative of the prevailing terrain topology upon movement of the powered wheelchair.

12. The powered wheelchair according to claim 11, wherein the control unit is configured to evaluate said data indicative of the prevailing terrain topology to adjust the characteristics of the control unit relating to control of drive and seat adjustments.

13. The powered wheelchair according to claim 1, wherein the pair of drive wheel assemblies is front wheel assemblies and the supporting wheel assembly is a rear wheel assembly.

14. The powered wheelchair according to claim 1, wherein the supporting rotatable wheel is a first supporting rotatable wheel and the supporting wheel assembly further includes a second supporting rotatable wheel.

15. A method for operating a powered wheelchair according to claim 1.

16. The method according to claim 15, wherein the method comprising the step of independently operating any one of the first rotation mechanism, the second rotation mechanism and the third rotation mechanism to adjust the wheelbase of the powered wheelchair.

17. The method according to claim 15, comprising at least three predetermined modes, such as an indoor mode, an outdoor mode and a stand-up mode, wherein the powered wheelchair is transformed into any one of the predetermined modes by operating any one of the first rotation mechanism, the second rotation mechanism and the third rotation mechanism to adjust the wheelbase of the powered wheelchair.

18. The method according to claim 16, wherein the wheelbase is shortened such that the powered wheelchair is transformed into an indoor mode, where the pair of the opposing drive wheel assemblies are positioned in a mid section of the powered wheelchair, as seen in a longitudinal direction X of the powered wheelchair.

19. The method according to claims 16, wherein the wheelbase is increased such that the powered wheelchair is transformed into an outdoor mode, where the pair of the opposing drive wheel assemblies are positioned in front of the seat frame of the powered wheelchair, as seen in a longitudinal direction X of the powered wheelchair.

20. The method according to claims 16, wherein the seat frame includes a first support section pivotably connected to a second support section, wherein the wheelbase is adjusted such that the seat frame is positioned in a substantially vertical orientation.
